(19) United States
(12) Patent Application Publication
(10) Pub. No.: US 2026/0205545 A1
(43) Pub. Date: Jul. 16, 2026

(54) SYSTEMS AND METHODS FOR DATA INTEGRATIONS WITHIN COMPUTING PLATFORMS VIA AN ORCHESTRATION LAYER

(71) Applicant: 8x8, Inc., Campbell, CA (US)

(72) Inventors: Cosmin Malutan, Sub-Coasta (RO); Florin-Gheorghe Prodaniuc, Cluj-Napoca (RO); Alin Constantin Screciu, Drobeta-Turnu Severin (RO)

(73) Assignee: 8x8, Inc., Campbell, CA (US)

(21) Appl. No.: 19/022,860

(22) Filed: Jan. 15, 2025

(51) Int. Cl. H04M 3/51; H04L 51/02

(52) U.S. Cl. CPC H04M 3/5191; H04L 51/02

(57) ABSTRACT

A system for integrating a first vendor with a computing platform, includes: a user interface generator configured to provide a user interface for allowing a user to create a data-flow diagram implementing a processing scheme to process communication data transmitted between the computing platform and the first vendor; wherein the user interface comprises a first set of one or more data-flow control objects for selection by the user, and a second set of one or more entity objects for selection by the user; wherein the one or more data-flow control objects comprise a first data-flow control object configured to implement data-flow control for the processing scheme; wherein the one or more entity objects comprise a first entity object representing the first vendor; and wherein the system is configured to enable the computing platform to process the communication data based on the created data-flow diagram.

### FIELD

The field of the subject disclosure relates to systems and methods for data integrations within computing platforms, and more specifically, to systems and methods for data integrations within computing platforms via an orchestration layer.

### BACKGROUND

When a vendor is to be integrated with a computing platform, integration is one-to-one, and is limited to the then-current functionality of that specific vendor. This is a rigid approach that is common with cloud-based software integration lacking scalability and adaptability, and limiting customer experience.

A vendor seeking a data integration with a desired computing platform will need to integrate with the data and resources (hardware and software) of the organization managing the computing platform. In such cases, this requires a custom-built connector to enable communication between different computing platforms. Also, to integrate with a third-party computing platform, the chatbot provider is required to directly implement its part of the integration, which takes a lot of time, resources (including effort from both the organization managing the computing platform and the vendor), and cost (time, working hours, computing resources, hosting). After the integration is completed, data-flow processing is often limited to the capabilities provided by the third-party vendor integrating with the computing platform. Accordingly, if the integrated chatbot does not provide certain desired functionality (such as sentiment analysis processing) in its workflow, the organization managing the computing platform or a customer thereof would have to separately integrate with a different vendor to provide the desired functionality, and spend extra effort, resource, and time, to implement the integration across multiple different parties including the organization that manages the computing platform to tie together the plurality of vendor integrations. This is an inefficient process.

Developing custom data integrations for every software vendor supported by a computing platform, and vice versa, results in high development costs, scalability challenges, and inconsistent user experiences. Additionally, such data integrations often do not leverage the true capabilities of the vast data endpoints of a computing platform when being integrated with a computing platform as third-party vendors are often not privy to the capabilities of another organization's computing platform.

Existing solutions do not provide an efficient way for vendors to integrate with computing platforms, while enabling flexible routing, state management, and dynamic message handling across different systems nor do they leverage capabilities of a computing platform, relative to data integrations, to provide contextually relevant, customized experiences for users that can scale and adapt with user needs.

### SUMMARY

Systems and methods for scalable and adaptable data integrations with/within a computing platform are described herein. For ease of explanation, a non-limiting example may be integrating bots (e.g., chatbot(s)) within software platforms, such as communications platforms, or components thereof such as contact center(s). In some embodiments, an integration system provides an orchestration layer that enables communication between data access paths (e.g., channels) of any computing platform, application or service, and one or more data vendors (e.g., chatbot providers). In some cases, the integrated system provides intelligent message routing, escalation mechanisms, message conversion, diverse node types for message flow control, or any combination of the foregoing. In further examples, data from interactions with data integrations (e.g., chatbot integrations) can be analyzed in real-time (or near real-time) and then leveraged to improve not only data process flows and data orchestration of a software platform (e.g., software communications platform), but also to improve operation of the software platform and user experience, for example, through the generation and surfacing of contextual data insights. In some examples, artificial intelligence/machine learning modeling may be adapted to utilize a vast plurality of data endpoints to generate contextually relevant data insights applicable to a software platform (e.g., software communications platform) including both back-end and front-end processing. Moreover, user experience for users of software platform can be improved through an adapted graphical user interface, for example, to enable usage of data integrations and the surfacing of contextually relevant data insights.

A system for integrating one or more chatbots with a contact center, the one or more chatbots comprising a first chatbot, includes: a user interface generator configured to provide a user interface for allowing a user to create a data-flow diagram implementing a processing scheme to process communication data transmitted between the contact center and the first chatbot; wherein the user interface comprises a first set of one or more data-flow control objects for selection by the user, and a second set of one or more entity objects for selection by the user; wherein the one or more data-flow control objects comprise a first data-flow control object configured to implement data-flow control for the processing scheme; wherein the one or more entity objects comprise a first entity object representing a first chatbot; and wherein the system is configured to enable the contact center to process the communication data transmitted between the contact center and the first chatbot in accordance with the processing scheme based on the created data-flow diagram.

Optionally, the one or more data-flow control objects comprise a second data-flow control object, and wherein the user interface is configured to allow the user to create a data path for the data-flow diagram, the data path connecting the first data-flow control object to the second data-flow control object, or to the first entity object.

Optionally, the system is configured to integrate the one or more chatbots with another contact center.

Optionally, the user interface comprises a display area configured to display a topography image representing the data-flow diagram, and wherein the first entity object is moveable in the display area.

Optionally, the one or more entity objects comprise a second entity object representing a second chatbot.

Optionally, the first chatbot and the second chatbot are associated with a same chatbot provider, or with different respective chatbot providers.

Optionally, the one or more entity objects comprise a second entity object representing at least a part of the contact center.

Optionally, the one or more entity objects comprises a second entity object representing an analytic tool or a processing tool.

Optionally, the first data-flow control object comprises a fan-out object having an input node and two or more output nodes.

Optionally, the first data-flow control object comprises a fan-in object having two or more input nodes and an output node.

Optionally, the first data-flow control object comprises a filter object implementing a filter that filters at least some of the communication data in response to a satisfaction of one or more criteria.

Optionally, the first data-flow control object comprises a check-and-emit object.

Optionally, the processing scheme implemented based on the data-flow diagram involves a handoff between the first chatbot and another chatbot, or between the first chatbot and a human agent.

Optionally, the processing scheme implemented based on the data-flow diagram involves a sentiment analysis to detect customer frustration or customer desire to communicate with a human agent.

Optionally, the user interface is configured to access a configuration interface from a chatbot provider to allow the user to create and/or to configure the first chatbot during a process to create the data-flow diagram.

Optionally, the user interface is configured to access another configuration interface from another chatbot provider to allow the user to create and/or to configure a second chatbot during the process to create the data-flow diagram.

Optionally, the system is a part of the data center or is communicatively coupled with the data center, and wherein the data center is configured to: receive the communication data; and process the communication data, in accordance with the communication scheme implemented based on the data-flow diagram.

A method involving one or more chatbots and a contact center, the one or more chatbots comprising a first chatbot, includes: providing a user interface by a user interface generator; receiving user input to create a data-flow diagram, wherein the data-flow diagram is configured to implement a processing scheme to process communication data transmitted between the contact center and the first chatbot; and storing configuration data based on the user input, the configuration data representing the created data-flow diagram.

Optionally, the method further comprises: receiving the communication data; and processing the communication data in accordance with the processing scheme implemented based on the data-flow diagram.

A product having a non-transitory medium storing a set of instructions, wherein an execution of the instructions will cause the method to be performed.

A system configured to integrate a contact center with a chatbot provided by a chatbot provider, includes: a communication interface configured to receive communication data being transmitted between the contact center and the chatbot; a non-transitory medium storing configuration data regarding a data-flow diagram, the data-flow diagram implementing a processing scheme to process the communication data transmitted between the contact center and the chatbot; and a processing unit configured to access the configuration data regarding the data-flow diagram, and to cause the communication data to be routed according to the processing scheme implemented based on the data-flow diagram.

Optionally, the configuration data represents a directed acyclic graph (DAG), wherein the data-flow diagram corresponds with the DAG.

Optionally, the data-flow diagram comprises a fan-in-node, a fan-out node, a filtering node, a check-and-emit node, an update state node, or any combination of two or more of the foregoing.

Optionally, the processing unit comprises a converter configured to convert the communication data to a standardized format, wherein the standardized format comprises a routing format, a chat format, an attachment format, an adaptive card format, or a data event format.

Optionally, the processing unit comprises an evaluator configured to evaluate the communication data using a check-and-emit node, and wherein the check-and-emit node is configured to evaluate the communication data to determine whether a condition is satisfied, and to emit an event if the condition is satisfied.

Optionally, the processing scheme implemented based on the data-flow diagram involves a handoff between the chatbot and another chatbot, or between the first chatbot and a human agent.

Optionally, the processing scheme implemented based on the data-flow diagram involves a sentiment analysis to detect customer frustration or customer desire to communicate with a human agent.

Optionally, the system is part of an orchestration layer configured to manage interaction between the chatbot and on-premise component(s) of the contact center.

Optionally, the system is a part of the data center, or is communicatively coupled with a component of the data center.

Optionally, the system further includes: a user interface generator configured to provide a user interface for allowing a user to create the data-flow diagram implementing the processing scheme to process the communication data transmitted between the contact center and the chatbot; wherein the user interface comprises a first set of one or more data-flow control objects for selection by the user, and a second set of one or more entity objects for selection by the user; wherein the one or more data-flow control objects comprise a first data-flow control object configured to implement data-flow control for the processing scheme; wherein the one or more entity objects comprise a first entity object representing the chatbot; and wherein the data-flow diagram is configured to enable the contact center to process the communication data transmitted between the contact center and the chatbot in accordance with the processing scheme.

A method involving a chatbot and a contact center, includes: receiving, via a communication interface, communication data being transmitted between the contact center and the chatbot; accessing, by a processing unit, configuration data for a data-flow diagram from a non-transitory medium, the data-flow diagram implementing a processing scheme to process the communication data transmitted between the contact center and the chatbot; and causing the communication data to be routed according to the processing scheme implemented based on the data-flow diagram.

Optionally, the configuration data represents a directed acyclic graph (DAG), wherein the data-flow diagram corresponds with the DAG.

Optionally, the data-flow diagram comprises a fan-in-node, a fan-out node, a filtering node, a check-and-emit node, an update state node, or any combination of two or more of the foregoing.

Optionally, the method further includes converting the communication data to a standardized format, wherein the standardized format comprises a routing format, a chat format, an attachment format, an adaptive card format, or a data event format.

Optionally, the method further includes evaluating the communication data using a check-and-emit node, and wherein the check-and-emit node is configured to evaluate the communication data to determine whether a condition is satisfied, and to emit an event if the condition is satisfied.

Optionally, the processing scheme implemented based on the data-flow diagram involves a handoff between the chatbot and another chatbot, or between the first chatbot and a human agent.

Optionally, the processing scheme implemented based on the data-flow diagram involves a sentiment analysis to detect customer frustration or customer desire to communicate with a human agent.

Optionally, the method is performed by a system that is a part of an orchestration layer configured to manage interaction between the chatbot and on-premise component(s) of the contact center.

Optionally, the method is performed by a system that is a part of the data center, or is communicatively coupled with a component of the data center.

Optionally, the method further includes: providing, by a user interface generator, a user interface for allowing a user to create the data-flow diagram implementing the processing scheme to process the communication data transmitted between the contact center and the chatbot; wherein the user interface comprises a first set of one or more data-flow control objects for selection by the user, and a second set of one or more entity objects for selection by the user; wherein the one or more data-flow control objects comprise a first data-flow control object configured to implement data-flow control for the processing scheme; wherein the one or more entity objects comprise a first entity object representing the chatbot; and wherein the data-flow diagram is configured to enable the contact center to process the communication data transmitted between the contact center and the chatbot in accordance with the processing scheme.

Other and further aspects and features will be evident from reading the following detailed description.

### BRIEF DESCRIPTION OF THE DRAWINGS

The drawings illustrate the design and utility of embodiments, in which similar elements are referred to by common reference numerals. In order to better appreciate how advantages and objects are obtained, a more particular description of the embodiments will be described with reference to the accompanying drawings. Understanding that these drawings depict only exemplary embodiments and are not therefore to be considered limiting in the scope of the claimed invention.

FIG. 1 is a communication system having a contact center integrated with chatbot providers and a third-party vendor.

FIG. 2 illustrates a system for integrating chatbot(s) with contact center(s) in accordance with some embodiments.

FIG. 3 illustrates an example data-flow diagram created using a user interface provided by the system of FIG. 2.

FIG. 4 illustrates another example of a data-flow diagram.

FIG. 5A illustrates an example of a filter node editor for configuring a filter node.

FIGS. 5B-5C illustrate an example of a check-and-emit node editor for configuring a check-and-emit node.

FIGS. 6A-6C illustrate an exemplary technique of configuring a DialogFlow® chabot.

FIG. 7 illustrates another example of a data-flow diagram.

FIG. 8 illustrates another example of a data-flow diagram.

FIG. 9 illustrates another example of a data-flow diagram.

FIG. 10 illustrates another example of a data-flow diagram.

FIG. 11 illustrates an example of a state diagram for a session.

FIG. 12 illustrates a method in accordance with some embodiments.

FIG. 13 illustrates another method in accordance with some embodiments.

FIG. 14 illustrates a specialized processing system in accordance with some embodiments.

FIG. 15 illustrates a variation of the communication system of FIG. 1, particularly showing the communication system having a neural network model.

### DESCRIPTION OF THE EMBODIMENTS

Various embodiments are described hereinafter with reference to the figures. It should be noted that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages of the invention shown. An aspect or an advantage described in conjunction with a particular embodiment is not necessarily limited to that embodiment and can be practiced in any other embodiments even if not so illustrated or if not so explicitly described.

Non-limiting examples of the present disclosure may be implementable as processing improvements for stand-alone applications or services, which can also be integrated into software computing platforms (“software platforms”). As software data platforms have layers of complexity, technical problems identified herein can be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8×8 Work® made available by 8×8, Inc. (e.g., additional supporting documentation available at http://www.8×8.com), among other examples.

The present disclosure is implementable to adapt and improve not only back-end data processing of a software platform but also front-end representations to users provided through a software platform providing further tangible evidence of the technical benefits of the present disclosure. For instance, this can be accomplished through data processing management for computer hardware and software utilized for provision of an exemplary software communications platform via data orchestration (e.g., data flow management for execution of processing components and related applications/services), data integration (e.g., bot connection to applications/services of a software communications platform); and data creation/retrieval (e.g., generation of contextual data insights and suggestions for developers and/or end users). Furthermore, benefits of the present disclosure may yield an improved graphical user interface (GUI) that may be adapted to enable usage of data integrations (e.g., chatbots) and surface contextually relevant data insights, suggestions, etc. for developers and/or end users presentable via applications, services, software platforms, and associated computing devices (e.g., user computing devices).

The present disclosure describes non-limiting examples of systems and methods for data integrations with/within software platforms. For instance, one or more bots may be integrated into a software communications platform to perform specific communications-based tasks associated with features and functionalities provided through a software communications platform. A bot may be a software program configured to interact with systems or users for the performance of specific tasks. In the context of a software communications platform, a bot may be utilized to be directed to communications tasks including management of conversations and associated data/metadata for communication management purposes (e.g., a chatbot). For ease of explanation, a chatbot may be used to describe examples of the present disclosure including within software communications platforms. However, it should be recognized that the present disclosure is able to be configured to work with any type of data integration in any application/service or software platform.

An exemplary software communications platform may include any technology described herein as “cloud-based platform implementation” individually or collectively. In one example, an exemplary software communications platform may comprise but is not limited to a combination of UCaaS, CPaaS, CPaaS features and functionalities, web services, and connected websites, administrative portals/consoles, connected to system infrastructure including phone systems hosted remotely by servers and accessible via the internet. An exemplary software communications platform can uniquely generate and manage contextual data from components and users thereof, which can then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but can also be represented in via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of technical advantages provided based on the one or more techniques described herein, may include, but are not limited to: provision of an improved data orchestration layer for management of data integrations with applications or services and related computer hardware; an adapted software communications platform with improved visibility into processing components further enabling improved issue spotting, remediation, and extend scalability and adaptability of software platforms via data process flow management of data integrations with/within the software platforms and associated system architecture (e.g., bot integrations with a cloud-based communication platform); improved processing efficiency (e.g., reduction in processing cycles, saving resources/bandwidth) for computing devices performing data orchestration, including creating data flows for digital communication across software platform(s), as well as data integration, including integration of bots in applications, services, and software platforms; reduction in latency of computing devices supporting software platforms which can include reduction in latency for back-end computing processing and resulting front-end output during execution of a software platform (e.g., software communications platform); creation, training, and adaptation of artificial intelligence (AI) modeling (e.g., machine learning (ML)) integrated within applications/services for processing improvement across a variety of practical of applications including data orchestration (e.g., data flow management for execution of processing components and related applications/services), data integration (e.g., bot connection to applications/services of a software communications platform); and data creation/retrieval (e.g., generation of contextual data insights and suggestions for developers and/or end users); an improved graphical user interface (GUI) adapted to surface contextually relevant data insights, suggestions, etc. for developers and/or end users including in applications, services, software platforms; and improved usability (user experience) of host applications/services including customization of data and data augmentation for usage of applications/services, and software platforms (e.g., software communications platforms), among other technical advantages.

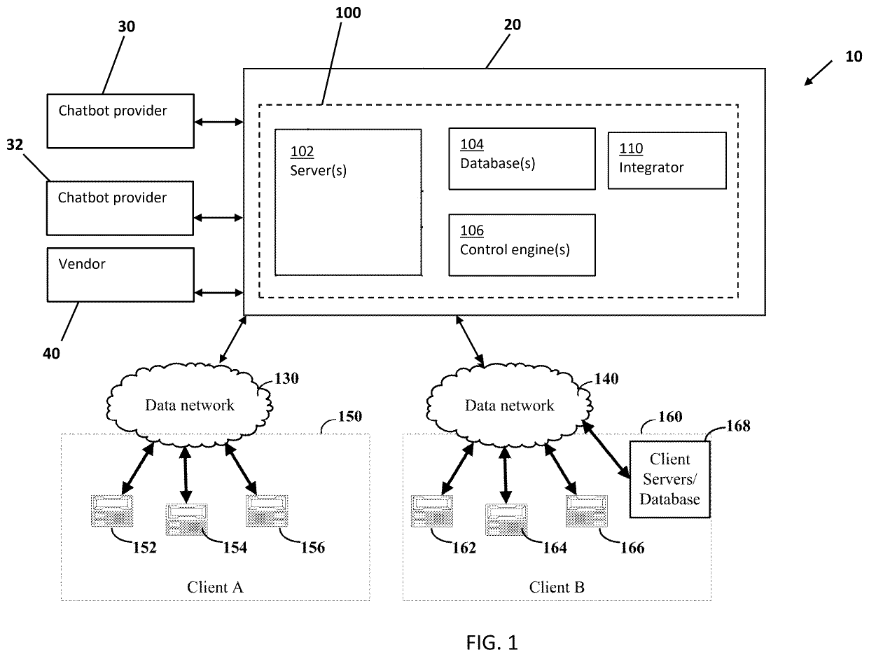

FIG. 1 illustrates a communication system 10 having a contact center 20 integrated with a chatbot provider 30. The contact center 20 includes a processing system 100 configured to provide one or more features described herein. As shown in the figure, the processing system 100 includes one or more servers 102, one or more databases 104 (e.g., non-transitory medium), and one or more control engines 106. The contact center 20 is configured to provide data communications for a plurality of endpoint devices 152, 154, 156, 162, 164, and 166 connected in one or more data networks 130 and 140. The endpoint devices may include data communications-enabled devices (e.g., IP phones, smart phones, tablets, and/or desktop computers with appropriate data communications software applications) and/or non-data communications endpoint devices (e.g., plain old telephone service (POTS) telephones and cellular-capable devices). Each endpoint device may respectively be associated with an account of a respective client. Endpoint devices may be associated with a particular client account by registering the endpoint device with a particular client account serviced by the contact center 20. Registered devices for each client account may be listed in a respective account settings file (not shown) stored in the database(s) 104. In this example, endpoint devices 152, 154, and 156 are associated within an account 150 for a first client A and endpoint devices 162, 164, and 166 are associated within an account 160 for a second client B. In other cases, any of the endpoint devices may not be associated with any account.

In some cases, the control engine(s) 106 may be one or more client-specific control engine(s) used to facilitate control of endpoint devices associated with a client device. The control of the endpoint devices may be associated with a variety of features including, for example, data communications services such as VoIP calls, audio and/or video conferencing, IPBX exchange servers, packet switching, and traffic management as well as non-data communications services including, but not limited to, website hosting, remote data storage, remote computing services, virtual computing environments. One or more of such features may be provided, for example, by a cloud computing network having one or more servers configurable to provide a data communications system for a plurality of clients. In some cases, the contact center 20 may implement at least a part of such cloud computing network.

The processing system 100 of the contact center 20 includes one or more processing circuits configured to implement the control engine(s) 106, which are configured to adjust the data communications provided for each client account according to a respective set of control directives (e.g., instructions). For instance, the control engine(s) 106 may adjust a manner in which endpoint devices 162, 164, 166 are controlled, and/or a manner of routing of a data communication for a client account, by generating client-specific sets of control data to the server 102. For example, the control engine(s) 106 may generate client-specific sets of control data by processing the respective set of control directives for the account in response to communication event data or other data prompts received at the contact center 20.

Although the control engine(s) 106 is illustrated as a component of the processing system 100 of the contact center 20, the control engine(s) 106 may be implemented in various locations in different embodiments. For example, the control engine(s) 106 for one or more client accounts may be implemented in a central server connected to, or incorporated with, the server(s) 102. Additionally or alternatively, one or more control engine(s) 106 may be implemented by one or more processing circuits maintained by the client (e.g., server/database 168). Similarly, the control directives may be stored locally within the control engines, or stored remotely (e.g., in a centralized database, in a database maintained by the client or a combination thereof).

In some cases, the communication routing and other services for data communications may be provided by the contact center 20 within a cloud service system (e.g., configured to provide virtual features to customers). In such cases, the contact center 20 may include hardware providing the cloud services located in one data center, or a number of different data centers with different physical locations. In some cases, the cloud services may be implemented using SIP servers, media servers, and servers providing other services to both data communications endpoint devices and the users of the data communications endpoint devices. In some instances, the various servers, including both the data communication server(s) and data analytic server(s) discussed herein, may have their functions spread across different physical and logical components. For instance, a cloud-based solution may implement virtual servers that can share common hardware and may be migrated between different underlying hardware. Moreover, in some cases, separate servers or modules may be configured to work together so that they collectively function as a single unified server. Thus, as used in this specification, the term “server” may refer to one or more servers, and may be located at the same facility or in different facilities at different geographical locations.

In some cases, at least one of the server(s) 102 of the contact center 20 may be a data communication server. Such data communication server may use different communication protocols to handle communication functions in different embodiments. For example, such data communication server may use session initiation protocol (SIP) to handle various communication functions (e.g., communication setup and tear down). It should be noted that the server(s) 102 of the contact center 20 is not limited to such example. In other cases, the server(s) 102 may be configured to establish a portion of the communication from the data communications endpoint devices to another data communications endpoint device, or to a gateway. In other cases, the contact center 20 may not include the data communication server. Instead, the contact center 20 may be configured to communicate with the data communication server.

Also, in some cases, at least one of the server(s) 102 of the contact center 20 may be a data analytics server configured to monitor and analyze communication data transmitted between the contact center 20 and endpoint devices, and/or between the contact center 20 and chatbot provider(s) (e.g., chatbot provider 30). For example, a data analytics server may be configured to track communication statistics about various different communication-related parameters, such as communication duration, communication date, communication time of day, called parties, endpoint devices, selected data centers, selected carriers, dropped communications, transferred communications, voicemail access, conferencing features, and others. In other cases, the contact center 20 may not include the data analytics server. Instead, the contact center 20 may be configured to communicate with the data analytics server.

In further cases, the server(s) 102 of the contact center 20 may include a data communication server configured to access communication summary metrics and the data analytics stored in the database(s) 104. For example, a script running the data communications server may parse communication processing XML (CPXML) documents to generate database queries that direct the data communications server to query, or subscribe to, communication length summaries for all communications made to endpoints that are registered to the server. The script may use the information to control how communications are routed as well as how different (customer or provider) services are invoked. In some cases, the server(s) 102 of the contact center 20 may be configured to interface with customer databases, or with third party servers. For instance, a CPXML document stored by in a cloud-based system may identify, based upon a received communication, a Uniform Resource Identifier (URI) that points to customer databases, or to a third-party server. Control directives provided from these servers, for example, in the form of a CPXML document, may be used to specify communication routing, or other functions.

As mentioned, the contact center 20 is integrated with the chatbot provider 30. Such may be accomplished by an integrator 110 at the contact center 20. The contact center 20 may optionally also integrate with other chatbot provider(s), such as chatbot provider 32. The contact center 20 may optionally also integrate with one or more vendor(s), such as vendor 40. The vendor 40 may be any third-party provider configured to provide analytics, data processing, resource, or any of other cloud-based features to assist and/or enhance the data processing capability of the contact center 20. The integrator 110 may be utilized to integrate the chatbot provider 30, the chatbot provider 32, the vendor 40, or any combination of the foregoing, with the contact center 20. In other cases, the integrator 110 may be separate from the processing system 100 of the contact center 20. For example, in other cases, the integrator 110 may be configured to communicate with the processing system 100 of the contact center 20. Thus, the integrator 110 may or may not be a part of the contact center 20.

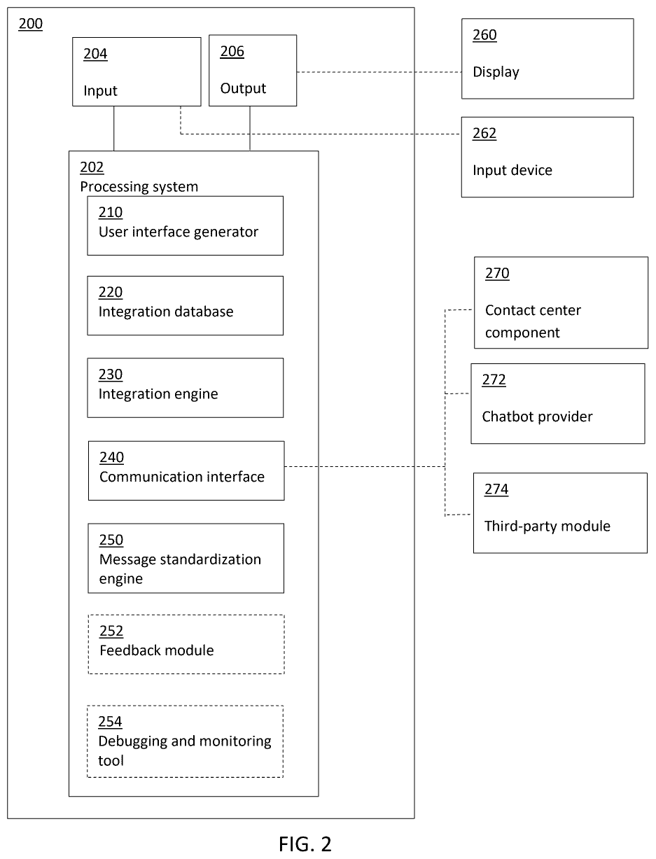

FIG. 2 illustrates a system 200 for integrating chatbot(s) with contact center(s) in accordance with some embodiments. The system 200 may be an example of the integrator 110 of FIG. 1, or may be utilized to implement the integrator 110. As shown in FIG. 2, the system 200 includes a processing system 202, an input 204 configured to receive user input from an input device 262, and an output 206 configured to provide output to a display 260. The processing system 202 includes a user interface generator 210 configured to provide a user interface for allowing a user to create a data-flow diagram implementing a processing scheme to process communication data transmitted between the contact center 20 and a first chatbot provided by the chatbot provider 30. In one implementation, the data-flow diagram corresponds, or is in the form of, a directed acyclic graph (DAG). An acyclic graph is a graph that contains no cycles, meaning there is no path from a node back to itself within the graph. In other cases, the data-flow diagram created using the user interface provided by the user interface generator 210 may be any of other types of graphs.

The processing system 202 also includes an integration database 220 storing integration information regarding the integration of the chatbot or chatbot provider 30 with the contact center 20. The integration information may include configuration data representing the data-flow diagram created by the user (of the user interface provided by the user interface generator 210). In the situation in which the data-flow diagram is in a form of DAG, the integration information may include data representing the DAG. The integration database 220 is not limited to storing integration information for integrating the chatbot provider 30 with the data center 20. The integration database 220 may be configured to store integration data integrating the data center 20 with multiple chatbots or multiple chatbot providers. The integration data may also integrate the data center 20 with other data center(s), and/or with other processing entities, which may be processing entities of the data center 20 or may be processing entities belonging to third-party vendors or partners of the data center 20.

The processing system 202 further includes an integration engine 220 comprising logic configured to process the integration information in the integration database 220 in order to enable the contact center 20 to process the communication data in accordance with the processing scheme implemented based on the data-flow diagram.

The processing system 202 also includes a communication interface 240 configured to communicate with third-party entities, such as chatbot provider 272, third-party module 274, etc. The communication interface 240 may also be configured to communicate with one or more contact center components 270, such as a component (e.g., server(s) 102, database(s) 104, control engine(s) 106, etc.) of the contact center 20 and/or a component of another contact center.

As shown in FIG. 2, the processing system 202 also includes a message standardization engine 250. The message standardization engine 250 is configured to convert communication data (e.g., messages) received via the communication interface 240 to a common format, ensuring compatibility across platforms. By means of non-limiting examples, the message standardization engine may convert route messages, chat messages, adaptive cards, attachments, data events, etc., into standardized messages. By standardizing these messages, the messages may be adapted to target APIs, such as APIs of contact centers, APIs of chatbot providers, APIs of third-party modules, etc.

As shown in FIG. 2, the processing system 202 also optionally includes a feedback module 252. The feedback module 252 is configured to analyze communication data (e.g., messages) and provide feedback regarding customer interactions. The feedback provided by the feedback module 252 may include a measure of customer satisfaction, customers'input, a suggestion for improvement, or any combination of the foregoing. The feedback module 252 may also provide and/or support post-chat or post-bot surveys to obtain feedback (e.g., real-time or near real-time feedback). As will be described in further detail herein, the system 200 is configured to integrate one or more chatbots with the contact center 20 to implement a communication data processing scheme. In the situation in which the processing scheme involves multiple chatbots, the feedback module 252 may be configured to analyze the entire communication session including blending of multiple chatbots to provide feedback globally for the entire communication experience. Such feature is more advantageous than obtaining feedback locally for only a single chatbot. In other cases, the feedback module 252 is optional, and the system 200 may not include the feedback module 252.

Optionally, the processing system 202 may also include a debugging and monitoring tool 254. The debugging and monitoring tool 254 allows a user to monitor flow of messages being performed based on the data-flow diagram he/she created. The user may view the flow of messages via the debugging and monitoring tool 254 in real-time or retroactively after a communication session is completed. The user may also utilize the debugging ad monitoring tool 254 to set breakpoint(s), and/or to inspect message content at various stages. This feature would allow the user to efficiently troubleshoot and optimize conversation flows.

Also, in some cases, the system 200 may be configured to provide documentation, tutorials (e.g., tutorial videos), best practices guides, etc., or any combination of the foregoing, for helping users create and/or troubleshoot data-flow diagrams via the user interface provided by the user interface generator 210 of the system 200.

In some cases, the system 200 may be a part of the data center 20. In other cases, the system 200 may be configured to communicatively couple with the data center 20. The data center 20 is configured to receive the communication data, and process the communication data in accordance with the communication scheme implemented based on the data-flow diagram (created using the user interface generated by the user interface generator 210 of the system 200).

Also, in some cases, the system 200 may be a part of an orchestration layer configured to manage interaction between one or more chatbots and on-premise component(s) of the contact center 20. An orchestration layer may be a central control point, managing and coordinating the interactions between various cloud services, applications, infrastructure components, or any combination of the foregoing, allowing them to work together by automating complex workflows and ensuring tasks are executed in the correct sequence across different systems. Thus, the orchestration layer acts as a conductor to manage the cloud environment efficiently.

It should be noted that any of the components 210, 220, 230, 240, 250, 252, 254 of the processing system 202 may be implemented using hardware, software, or a combination of both. Also, two or more of the components 210, 220, 230, 240, 250, 252, 254 may be combined or integrated as one processing unit. In addition, in some cases, the processing system 202 may not include the message standardization engine 250, the feedback module 252, and/or the debugging and monitoring tool 254. Furthermore, one or more of the components 210, 220, 230, 240, 250, 252, 254 may be implemented using a specialized processing unit that is unconventional in the sense that such specialized processing unit may include one or more processing features not present in a generic off-the-shelf computer. Also, in some cases, one or more of the components 210, 220, 230, 240, 250, 252, 254 may be implemented using, or may include, a neural network model.

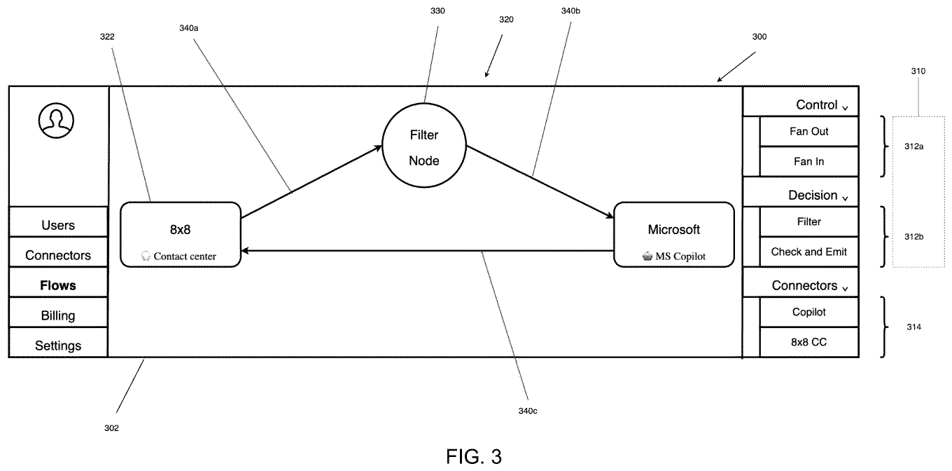

FIG. 3 illustrates an example a data-flow diagram 320 created using a user interface 300 provided by the interface generator 210 of the system 200 of FIG. 2. As shown in the figure, the user interface 300 includes a first set of data-flow control object(s) 310 for selection by the user, and a second set of entity object(s) 314 for selection by the user.

The first set of data-flow control object(s) 310 includes one or more flow objects 312a, and/or one or more decision objects 312b. Each data-flow control object is configured to implement data-flow control for the processing scheme governed by the data-flow diagram 320.

For examples, flow object(s) 312a may include a fan-in object and a fan-out object for allowing a user to select for incorporation into the data-flow diagram 320. The fan-in object is configured to implement a consolidation of communication data (e.g., messages) from multiple sources (two or more sources) for output to a receiving entity (e.g., device component, functional component, node, etc.). The fan-in object may be utilized to implement aggregation of data and/or parallel processing of data. In some cases, the fan-in object may have two input nodes, and an output node. In other cases, the fan-in object may have more than two input nodes and an output node. The fan-out object is configured to implement a distribution of communication data (e.g., messages) from a source to multiple receiving entities (e.g., device components, functional components, nodes, etc.). The fan-out object may be utilized to implement broadcasting of messages, and/or parallel processing of data. In some cases, the fan-out object may have an input node and two output nodes. In other cases, the fan-out object may have an input node and more than two output nodes.

In some cases, each flow object (e.g., fan-in object, fan-out object, etc.) does not involve utilization of any logic or condition evaluation. In other cases, one or more of the flow objects may involve utilization of logic and/or condition evaluation. For example, a fan-in object may incorporate a logic for determining whether a condition is met, and may combine data if the condition is met. Similarly, a fan-out object may incorporate a logic for determining whether a condition is met, and may distribute data if the condition is met.

Decision object(s) 312b may include a filter object, a check-and-emit object, a transform object, a routing object, a user-defined control object, or any combination of the foregoing, for allowing a user to select for incorporation into the data-flow diagram 320. A filter object represents a filter (or data filtering) to be incorporated into the processing scheme defined by the data-flow diagram 320 being created. The filter may be configured to filter communication data based on one or more criteria. A check-and-emit object represents a check-and-emit module configured for event generation (emitting an event) to be incorporated into the processing scheme defined by the data-flow diagram 320. The generation of the event (e.g., a handoff event, a termination event, etc.) may be performed based on a satisfaction of one or more defined criteria. A transform object represents a data transformation to be incorporated into the processing scheme defined by the data-flow diagram 320. A routing object represents a data routing to be incorporated into the processing scheme defined by the data-flow diagram 320. A user-defined control object may represent any data processing defined by the user for incorporation into the processing scheme defined by the data-flow diagram 320.

In some cases, the data-flow control object(s) 310 may include an update-state object (node) representing an update-state module. The update-state module is configured to updates the state or context of the conversation, enabling adaptive interactions. For example, the update-state module may update (e.g., modify) a state and/or a context of a conversation in a customer's session dynamically. In some cases, the update-state module may be utilized to track a progress of a conversation between a customer and one or more chatbots.

The entity object(s) 314 may include one or more entity objects representing one or more chatbots or chatbot providers, one or more analytic tools, one or more processing tools, one or more third-party entity, or any combination of the foregoing. In some cases, if there are multiple chatbots (e.g., first and second chatbots), they may be associated with a same chatbot provider (e.g., provided by the same chatbot provider), or with different respective chatbot providers (e.g., provided by different respective chatbot providers). Each chatbot may have an associated chatbot identifier. In such cases, when an entity object 314 representing a certain chatbot is selected by the user via the user interface 320, the system 200 keeps track of the selected chatbot via the chatbot identifier. In some cases, each chatbot identifier may be associated with a chatbot profile, a link for the chatbot, or any of other information regarding the chatbot.

In some cases, the entity objects 314 may be categorized into source node(s) and sink node(s). A source node acts as the initial point of entry for messages into the communication system. It's where the conversation starts, pulling in queries or commands from users or triggering events. The source node may be extended to include various types of sources (i.e., not just chatbot, chatbot providers, and contact centers), such as direct user input, scheduled triggers, or external event listeners. A sink node serves as the endpoint for messages within the communication system. It may be where the chatbot sends a response to the customer, logs a conversation, or triggers an action. In some cases, a sink node may be customized to handle different types of actions or responses, thereby enhancing a flexibility of the communication system.

To create the data-flow diagram 320, a user of the user interface 300 may select any of the data-flow control objects 310 and entity objects 314. For example, the user may move a cursor over one of these objects 310, 314, and may click on the object to select it. In some cases, after the user selects one of the objects 310, 314, the selected object may be moveable to a display area 302. In one implementation, the user may drag the selected object to the display area 302 for inclusion of it into the data-flow diagram 320. In another implementation, after the user selects one of the objects 310, 314, the selected object will appear in the display area 302, and the user may then position the selected object to a desired position in the display area 302.

As shown in FIG. 3, the display area 302 of the user interface 300 is for allowing the user to create the data-flow diagram 320. In the illustrated example, the user has selected a first entity object 322, a second entity object 324, and a data-flow control object 330, and has utilized these objects to create the data-flow diagram 320. When creating the data-flow diagram 320, the user may move the objects 322, 324, 330 in the display area 302. The user may also create arrows 340a-340c using the user interface 300 to connect these objects logically, thereby creating a data path for the data-flow diagram 320.

In particular, in the illustrated example, the created data-flow diagram 320 includes the first entity object 322 representing the contact center 20 or a component of the contact center 20. The created data-flow diagram 320 also includes the second entity object 324 representing a chatbot or a chatbot provider of the chatbot. As shown in the figure, the data-flow diagram 320 further includes the data-flow control object 330 representing a filter. In the data-flow diagram 320, a first arrow 340a is provided to connect an output of the first entity object 322 with an input of the data-flow control object 330, and a second arrow 340b is provided to connect the output of the data-flow control object 330 with an input of the second entity object 324. Also, a third arrow 340c is provided to connect an output of the second entity object 324 with an input of the first entity object 322.

Accordingly, the example of the data-flow diagram 320 of FIG. 3 represents and/or defines a processing scheme to be executed, wherein the processing scheme involves processing of communication data transmitted data between the contact center 20 (or a component of the contact center 20) and the chatbot or chatbot provider. In particular, in the processing scheme, communication data received by the contact center 20 or a component of the contact center 20 (represented by the first entity object 322) is passed to a filter (represented by the data-flow control object 330). The filter checks to see if a filtering criterion is met, and if so, the filter then perform data filtering. The filtered or unfiltered communication data is then passed from the filter to the chatbot or chatbot provider (represented by the second entity object 324). Also, communication data output by the chatbot or chatbot provider (represented by the second entity object 324) is transmitted to the contact center 20 or a component of the contact center 20 (represented by the first entity object 322).

As shown in the above example, the system 200 is advantageous because it enables the contact center 20 to process the communication data transmitted between the contact center 20 and the chatbot or chatbot provider in accordance with the processing scheme based on the created data-flow diagram 320.

It should be noted that the data-flow diagram 320 that can be created using the user interface 300 is not limited to the above example, and that the data-flow diagram 320 may have other configurations in other cases.

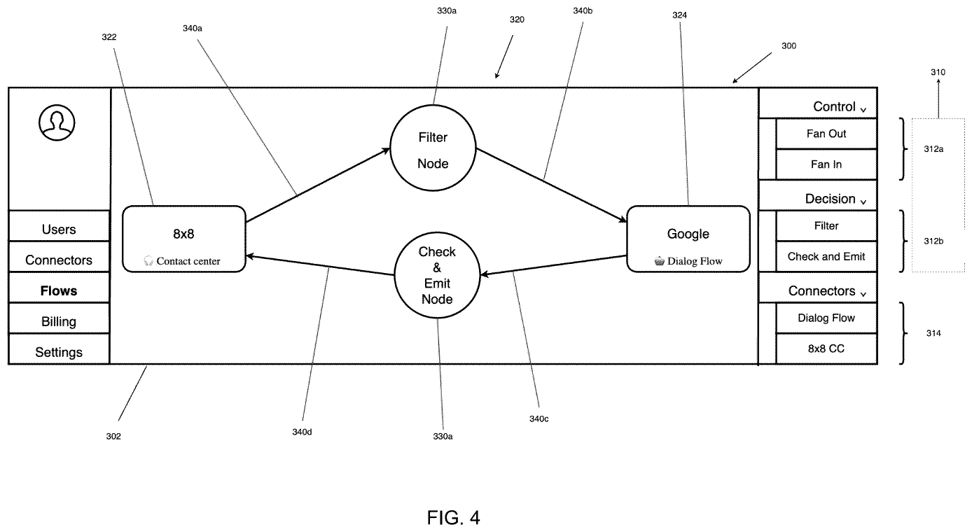

FIG. 4 illustrates another example of a data-flow diagram 320 created using the user interface 300. In the illustrated example, the created data-flow diagram 320 includes a first entity object 322 representing the contact center 20 or a component of the contact center 20. The created data-flow diagram 320 also includes a second entity object 324 representing a chatbot or a chatbot provider of the chatbot. As shown in the figure, the data-flow diagram 320 further includes a first data-flow control object 330a (filter object) representing a filter, and a second data-flow control object 330b (check-and-emit object) representing a check-and-emit module. In the data-flow diagram 320, a first arrow 340a connects an output of the first entity object 322 with an input of the data-flow control object 330, and a second arrow 340b connects the output of the data-flow control object 330 with an input of the second entity object 324. Also, a third arrow 340c connects an output of the second entity object 324 with an input of the second data-flow control object 330b, and a fourth arrow 340d is provided to connect an output of the second data-flow control object 330b with an input of the first entity object 322.

Accordingly, the data-flow diagram 320 represents a processing scheme to be executed, in which communication data received by the contact center 20 or a component of the contact center 20 (represented by the first entity object 322) is passed to a filter (represented by the data-flow control object 330). The filter checks to see if a filtering criterion is met, and if so, the filter then perform data filtering. The filtered or unfiltered communication data is then passed from the filter to the chatbot or chatbot provider (represented by the second entity object 324). Also, communication data output by the chatbot or chatbot provider (represented by the second entity object 324) is transmitted to the check-and-emit module (represented by the second data-flow control object 330b). The check-and-emit module checks to see if an emit condition is satisfied, and if so, the check-and-emit module then emits an event. For example, the check-and-emit module may be configured to check to see if the communication data indicates that a customer wants to speak to a live agent, or if a chatbot is unable to assist with the customer. If so, the check-and-emit module then emits a “handoff” event to switch the communication with a live agent (instead of the chatbot). The communication data or the emitted event is then transmitted to the contact center (represented by the first entity object 322). Thus, the check-and-emit node is configured to intercept messages for detection of certain situation (e.g., detection of escalation), and dynamic state update.

In the illustrated example, both the first data-flow control object 330a (representing the filter) and the second data-flow control object 330b representing the check-and-emit module are user configurable. Such may be accomplished by the user interface 300 providing a filter node editor and a check-and-emit node editor.

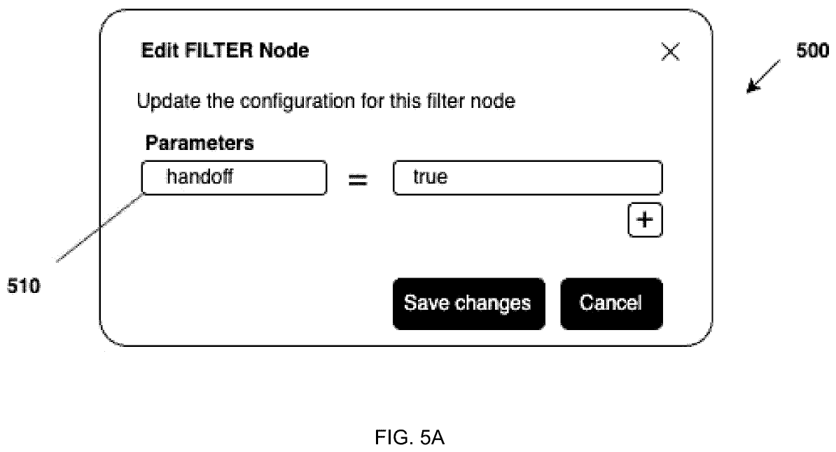

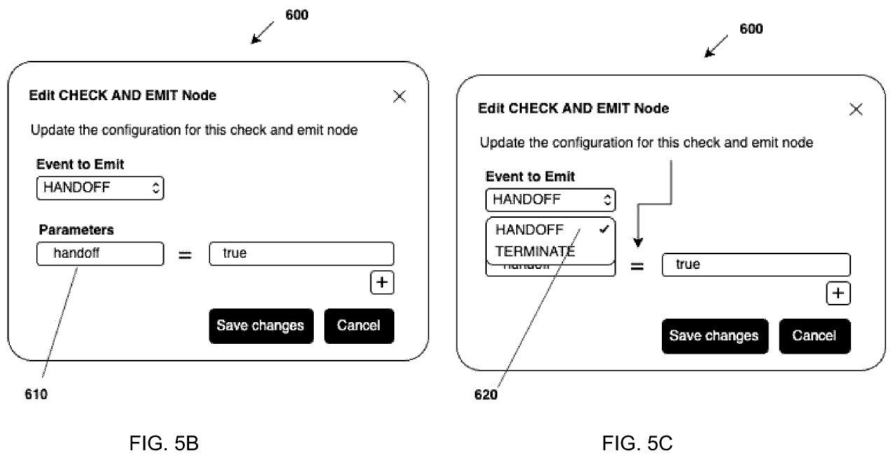

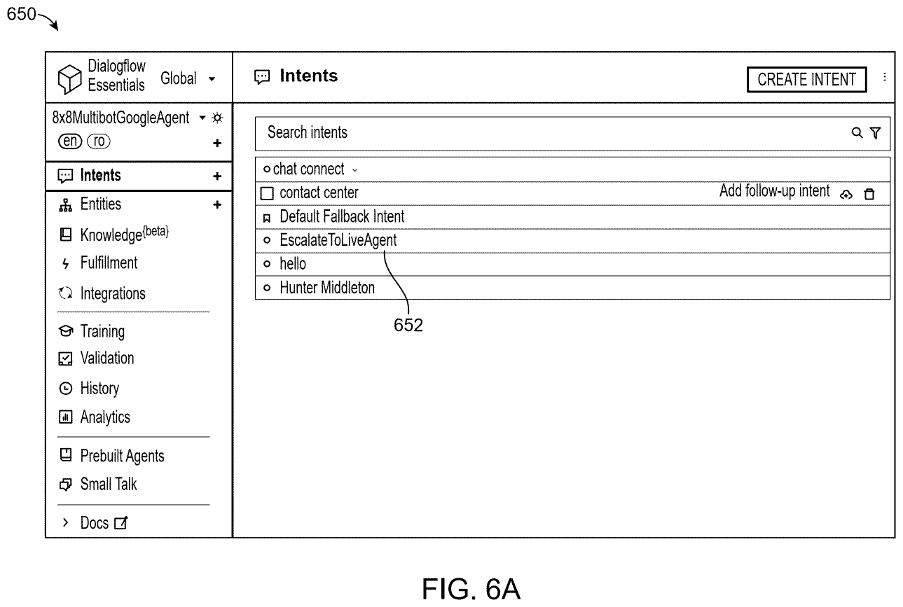

FIG. 5A illustrates an example of a filter node editor 500. The filter node editor 500 may be utilized to configure the data-flow control object 330a (filter object) of FIG. 4. As shown in the example, the user may define the filtering parameter 510 for filtering the communication data. The filtering parameter in the example is defined by the user as “handoff=true” for the filter. Thus, if the communication data intercepted by the filter indicates that a handoff is to be implemented (handoff=true), then the filter will filter the communication data, thereby preventing the communication data from being passed downstream (e.g., to the chatbot represented by the second entity object 324 in FIG. 4).

FIGS. 5B-5C illustrate an example of a check-and-emit node editor 600 for configuring a check-and-emit node. The check-and-emit node editor 600 may be utilized to configure the data-flow control object 330b (check-and-emit object) of FIG. 4. As shown in FIG. 5B, the user may define a parameter 610 of a criterion using the check-and-emit node editor 600. In the example, the parameter 610 is “handoff”, and the criterion to check by the check-and-emit module (represented by the check-and-emit object being edited) is whether “handoff”=true. FIG. 5C shows the user defining an event 620 to emit using the check-and-emit node editor 600. In the illustrated example, the user utilized the check-and-emit node editor 600 to prescribe a “handoff” event to be emitted based on a satisfaction of the criterion defined according to FIG. 5B. Accordingly, if the check-and-emit module (represented by the check-and-emit object 330b) detects that the criterion “handoff”=true is satisfied, the check-and-emit module then emits a “handoff” event. In one implementation, the check-and-emit module may generate a message ‘handoff” and may send such message to a receiving entity. It should be noted that the check-and-emit editor 600 may be utilized to define more than one criterion. Also, in other cases, the parameter may be different from “handoff”. In addition, in other cases, the event to emit may be any event that is different from “handoff”. For example, in other cases, the event to emit may be a “terminate” event. In such cases, when the event emission criterion is met, the check-and-emit module may generate a message or a control signal to cause a chatbot communication session to be terminated.

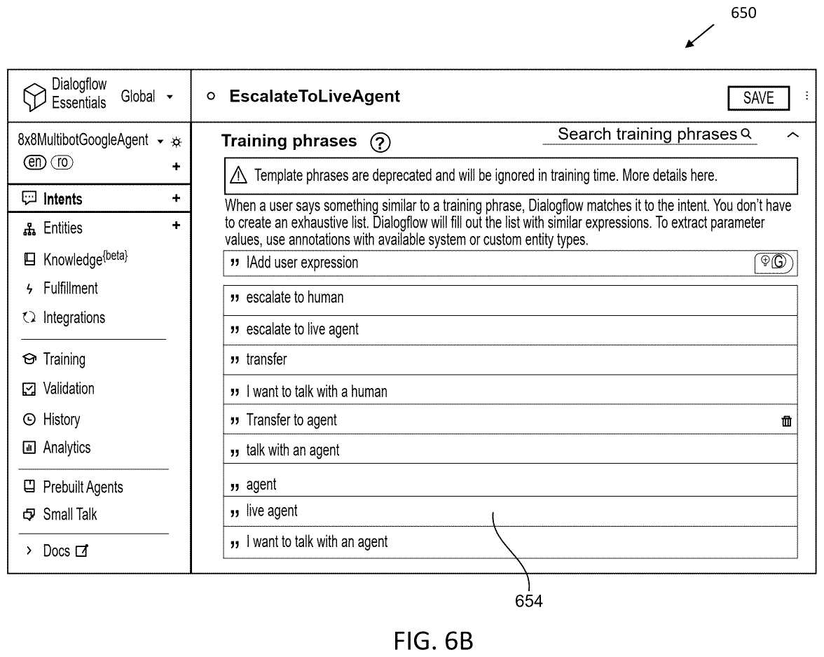

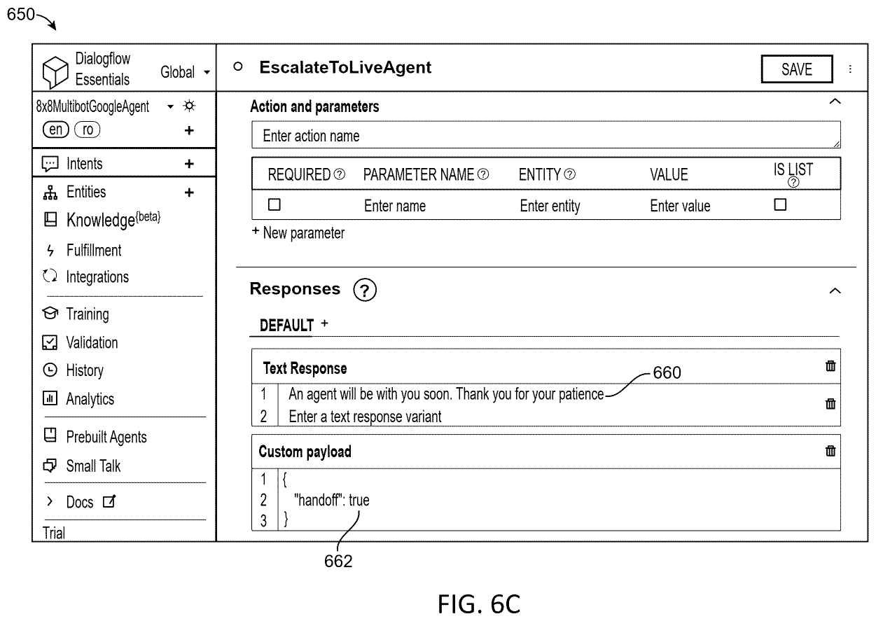

In the exemplary data-flow diagram 320 of FIG. 4, the filter represented by the filter object 330a and the check-and-emit module represented by the check-and-emit object 330b are configured to cooperate with the contact center 20 or a component of the contact center 20 (represented by the first entity object 322) and the chatbot or chatbot provider (represented by the second entity object 324). The chatbot associated with the second entity object 324 may be configured in some cases. In the illustrated example of FIG. 4, the chatbot is provided by DialogFlow®. The user may access a chatbot configurator for configuring such chatbot. FIGS. 6A-6C illustrate an example of a chatbot configurator 650 for configuring a DialogFlow® chabot. The chatbot configurator 650 may be provided by the chatbot provider. As shown in FIG. 6A, the chatbot configurator 650 allows a user to define different intents 652. In the illustrated example, one of the intents 652 is “Escalate to live agent”. As shown in FIG. 6B, the chatbot configurator 650 also allows the user to input different phrases 654 for a certain defined intent. In the examples shown in the figure, all the phrases are for training the chatbot to detect the intent “Escalate to live agent”. Accordingly, if the chatbot receives any of such phrases or similar phrases in the communication with a customer, the chatbot will determine that the customer has an intent to contact a live agent. FIG. 6C illustrates the chatbot configurator 650 providing an input interface for allowing the user to define action and parameter(s), so that when an intent is detected, the chatbot will provide a certain response 660 and/or will provide a certain custom payload 662. In the illustrated example, if the chatbot detects that the customer's intent is to communicate with a live agent, the chatbot will provide the response “An agent will be with you soon. Thank you for your patience”. The chatbot is also configured to provide the custom payload “handoff”: true.

As described with reference to FIG. 4, and FIGS. 5B-5C, the check-and-emit object 330b is configured (based on the check-and-emit editor 600 of FIGS. 5B-5C) to determine whether the condition or criterion “handoff”=true is satisfied. If so, the check-and-emit module will emit a “handoff” event. Since the chatbot is configured by the chatbot configurator 650 of FIG. 6C to output the custom payload “handoff”: true, following the data path of the data-flow diagram 320 of FIG. 4, the check-and-emit module will detect that the condition or criterion “handoff”=true is satisfied, and will emit the “handoff” event when the customer's intent to contact a live agent is detected. Upon receiving the “handoff” event by the contact center 20, the contact center 20 will then connect the customer with a live agent. The contact center 20 may also transmit the entire communication history in the communication session (between the customer and the chatbot) to the live agent.

Also, as described with reference to FIG. 4 and FIG. 5A, the filter object 330a is configured (base on the filter editor 500 of FIG. 5A) to determine whether the condition or criterion “handoff”=true is satisfied. If so, the filter will filter communication data so that future customer communication in the communication session is not sent to the chatbot.

In other cases, the chatbot provider may be configured to send escalation event through an API to the contact center 20. In such cases, the data-flow diagram 320 may not include a check-and-emit node, and the processing scheme may not involve a check-and-emit module represented by the check-and-emit node.

As shown in the above example, the user interface provided by the system 200 is advantageous because it allows the user to easily configure various components (e.g., chatbot(s), filter(s), processing module(s), etc.) involved in the processing scheme so that they cooperate with each other to achieve a desired result in the processing scheme. In the particular example shown in FIG. 4, the user interface 300 allows creation of data-flow diagram 320, which enables escalation to a live agent from chatbot that does not have support for it. Accordingly, when the chatbot provider lacks native support for escalation, the system 200 and/or the contact center 20 intercepts custom messages and emits escalation events for seamless handover to a human agent.

In some cases, the user interface 300 provided by the system 200 of FIG. 2 may provide a link, a selectable object, a portal, etc., for the user to access the chatbot configurator 650 to create and/or to configure the chatbot. In other cases, the user may separately access the chatbot configurator 650 without using the user interface 300. Also, in some cases, the user interface 300 is not limited to access one chatbot configurator (e.g., configuration interface) from one chatbot provider, and may be configured to access multiple chatbot configurators from different chatbot providers in order to allow the user to create and/or to configure multiple chatbots from different respective chatbot providers during a process to create the data-flow diagram.

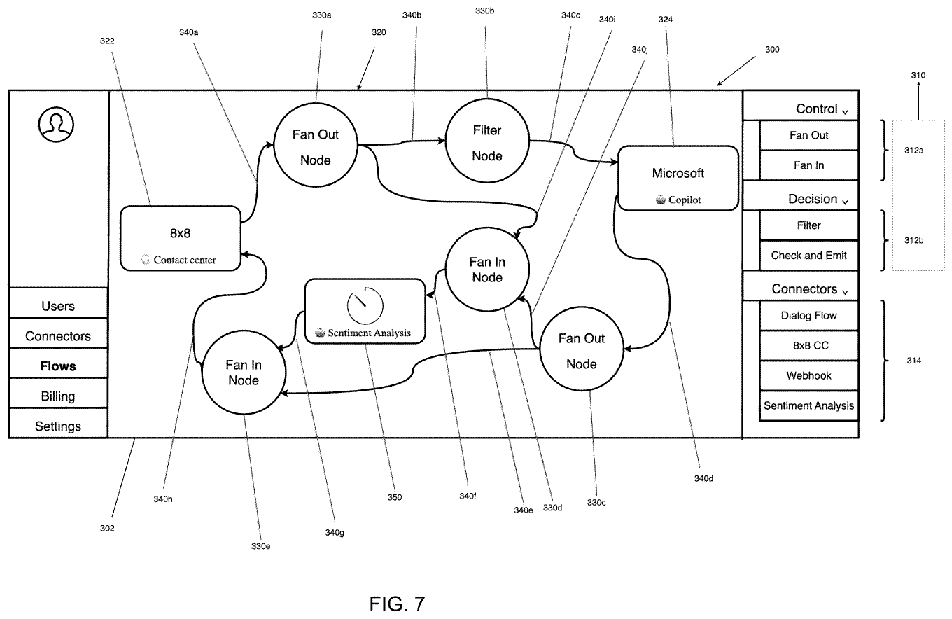

FIG. 7 illustrates another example of a data-flow diagram 320 created using the user interface 300. In the illustrated example, the created data-flow diagram 320 includes a first entity object 322 representing the contact center 20 or a component of the contact center 20. The created data-flow diagram 320 also includes a second entity object 324 representing a chatbot or a chatbot provider of the chatbot. As shown in the figure, the data-flow diagram 320 further includes a first data-flow control object 330a that is a fan-out object representing a fan-out node, a second data-flow control object 330b that is a filter object representing a filter, a third data-flow control object 330c that is a fan-out object representing another fan-out node, a fourth data-flow control object 330d that is a fan-in object representing a fan-in node, and a fifth data-flow control object 330e that is a fan-in object representing another fan-in node. In the data-flow diagram 320, a first arrow 340a connects an output of the first entity object 322 with an input of the first data-flow control object 330a (fan-out object). A second arrow 340b connects a first output of the first data-flow control object 330a (fan-out object) to an input of the second data-flow control object 330b (filter object). A third arrow 340c connects an output of the second data-flow control object 330b (filter object) to an input of the second entity object 324 (representing a chatbot or a chatbot provider). In the data-flow diagram 320, a fourth arrow 340d connects an output of the second entity object 324 to an input of the third data-flow control object 330c (fan-out object), a fifth arrow 340e connects a first output for the third data-flow control object 330c to a first input of the fourth data-flow control object 330d (fan-in object), a sixth arrow 340f connects an output of the fourth data-flow control object 330d to an input of a third entity object 350 representing a sentiment analyzer, a seventh arrow 340g connects an output of the third entity object 350 to a first input of the fifth data-flow control object 330e (fan-in object), and an eighth arrow 340h connects an output of the fifth data-flow control object 330e to an input of the first entity object 322 (representing the contact center 20 or a component of the contact center 20). As shown in the figure, the data-flow diagram 320 further includes a ninth arrow 340i connecting a second output of the first data-flow control object 330a (fan-out object) to a second input of the fourth data-flow control object 330d, and a tenth arrow 340j connecting a second output of the third data-flow control object 330c to a second input of the fifth data-flow control object 330e.

Accordingly, the data-flow diagram 320 FIG. 7 represents a processing scheme to be executed, in which communication data received by the contact center 20 or a component of the contact center 20 (represented by the first entity object 322) is duplicated to obtain first communication data and second communication data (corresponding with the fan-out feature of the first data-flow control object 330a). The first communication data is passed to the filter (represented by the second data-flow control object 330b), and then to a chatbot or chatbot provider (represented by entity object 324). The second communication data is passed to a sentiment analyzer (represented by the third entity object 350). Also, in the processing scheme, communication data from the chatbot or chatbot provider (represented by the entity object 324) is duplicated to obtain first communication data and second communication data (corresponding with the fan-out feature of the third data-flow control object 330c). The first communication data from the chatbot or chatbot provider is passed to the contact center (represented by the entity object 322). The second communication data (which is the same as the first communication data) is passed to the sentiment analyzer (represented by entity object 350). Thus, the sentiment analyzer receives communication data from both the contact center and the chatbot/chatbot provider based on the data-flow diagram 320. The sentiment analyzer analyzes the communication data, and determines a sentiment of a customer (e.g., whether the customer is satisfied, frustrated, confused, etc.). The sentiment analyzer then provides a result of the sentiment analysis to the contact center 20. In some cases, the sentiment analyzer may be configured to detect an escalation, and to short circuit the chatbot if an escalation trigger is detected.

The sentiment analyzer is configured to intelligently detect customer sentiment or recognize when a conversation is stuck in a loop (e.g., infinite loop). Upon detection of either situation, the sentiment analyzer triggers an immediate escalation, bypassing the chatbot escalation process. This ensures that critical issues are addressed promptly, enhancing customer satisfaction and streamlining the resolution process. Thus, the sentiment analyzer addresses a challenge in automated customer interactions—detecting and responding to user frustration. This feature can significantly enhance customer satisfaction by performing (1) seamless handover, and/or (2) loop detection. For seamless handover, the sentiment analyzer is configured to detect negative sentiment or frustration in a customer's messages, and trigger a handover to a human agent, ensuring that the customer receives the support he/she needs without unnecessary friction. For loop detection, the sentiment analyzer is configured to identify situations where the conversation is not progressing (e.g., the chatbot and the customer are stuck in a loop). In such case, in response to the detected situations, the sentiment analyzer can redirect or escalate the conversation to a human agent.

In some cases, the sentiment analyzer is configured to employ a pre-trained model to analyze text of the communication data (e.g., messages), and identify cues for potential escalation. If the sentiment analyzer detects the potential escalation, then the sentiment analyzer generates and outputs an escalation message. The escalation message may be relayed back to the contact center 20 or a component of the contact center 20, which will handle the escalation. For example, the contact center 20 may generate and transmit a message to inform the customer that he/she is being transferred to a live agent, and may connect the customer with a live agent. The contact center 20 may also transmit the entire communication (between the customer and the chatbot) in the communication session to the live agent. This technique bypasses the need for the chatbot provider to handle the handover to a live agent.

Also, in some cases, the sentiment detected by the sentiment analyzer over time may be analyzed to provide valuable insights into chatbot performance and customer satisfaction, guiding further refinements to conversation flows or chatbot responses. Accordingly, in some cases, an output of the sentiment analyzer may be provided to the chatbot provider for improving (e.g., re-configuring) one or more chatbots provided by the chatbot provider.

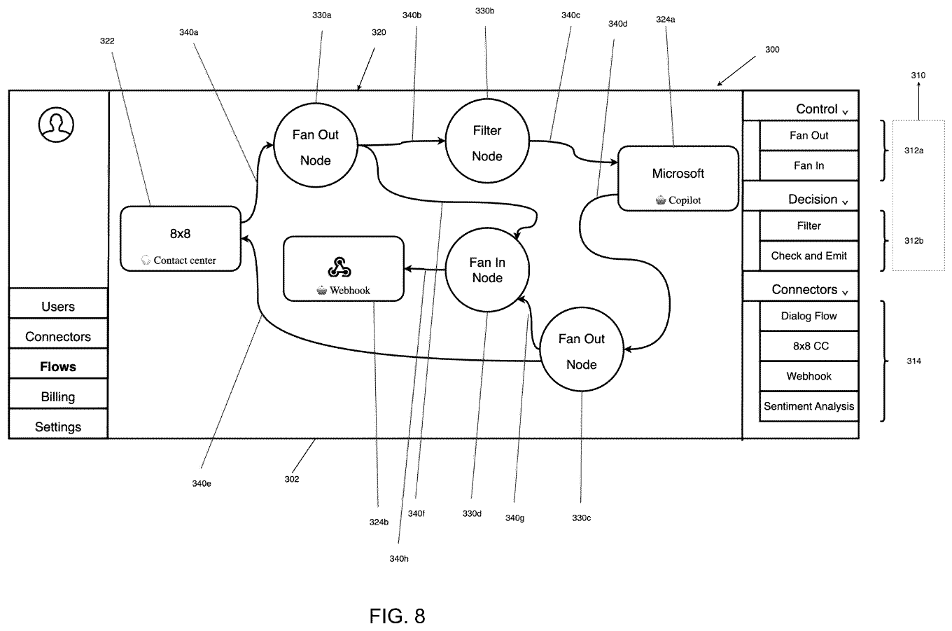

FIG. 8 illustrates another example of a data-flow diagram 320 created using the user interface 300. In the illustrated example, the created data-flow diagram 320 includes a first entity object 322 representing the contact center 20 or a component of the contact center 20. The created data-flow diagram 320 also includes a second entity object 324a representing a chatbot or a chatbot provider of the chatbot, and a third entity object 324b representing a third-party entity configured to provide a certain processing function. In the illustrated example, the third-party entity is a webhook module configured to automatically send data between applications when a certain event occurs. In other cases, the entity object may represent any of other types of third-party entities configured to provide any of other types of data processing. As shown in the figure, the data-flow diagram 320 further includes a first data-flow control object 330a that is a fan-out object representing a fan-out node, a second data-flow control object 330b that is a filter object representing a filter, a third data-flow control object 330c that is a fan-out object representing another fan-out node, and a fourth data-flow control object 330d that is a fan-in object representing a fan-in node. In the data-flow diagram 320, a first arrow 340a connects an output of the first entity object 322 (representing the contact center 20) to an input of the first data-flow control object 330a (fan-out object), a second arrow 340b connects a first output of the first data-flow control object 330a to an input of the second data-flow control object 330b (representing a filter), and a third arrow 340c connects an output of the second data-flow control object 330b to an input of the second entity object 324a (representing the chatbot or chatbot provider). Also, in the data-flow diagram 320, a fourth arrow 340d connects an output of the second entity object 324a (representing the chatbot or chatbot provider) to an input of the third data-flow control object 330c (fan-out object), and a fifth arrow 340e connecting a first output of the third data-flow control object 330c to an input of the first entity object 322 (representing the contact center 20 or a component of the contact center 20). In the data-flow diagram 320, a sixth arrow 340f connects a second output of the first data-flow control object 330a (fan-out object) to a first input of the fourth data-flow control object 330 d (fan-in object), a seventh arrow 340g connects a second output of the third data-flow control object 330c (fan-out object) to a second input of the fourth data-flow control object 330d (fan-in object), and an eighth arrow 340h connects an output of the fourth data-flow control object (fan-in object) to the third entity object 324b.

Accordingly, the data-flow diagram 320 of FIG. 8 represents a processing scheme to be executed, in which communication data received by the contact center 20 or a component of the contact center 20 (represented by the first entity object 322) is duplicated to obtain first communication data and second communication data (corresponding with the fan-out feature of the first data-flow control object 330a). The first communication data is passed to the filter (represented by the second data-flow control object 330b), and then to a chatbot or chatbot provider (represented by second entity object 324a). The second communication data is passed to the third-party entity (represented by the third entity object 324b). Also, in the processing scheme, communication data from the chatbot or chatbot provider (represented by the second entity object 324a) is duplicated to obtain first communication data and second communication data (corresponding with the fan-out feature of the third data-flow control object 330c). The first communication data from the chatbot or chatbot provider is passed to the contact center 20 or a component of the contact center 20 (represented by the entity object 322). The second communication data (which is the same as the first communication data) from the chatbot or chatbot provider is passed to the third-party entity (represented by third entity object 324b). Thus, according to the data-flow diagram 320, while communication data is passed between the contact center 20 or a component of the contact center 20 (represented by the first entity object 322) and the chatbot or chatbot provider (represented by the second entity object 324a), the communication data transmitted between the contact center 20 or a component of the contact center 20 and the chatbot or chatbot provider is also passed to the third-party entity (represented by the third entity object 324b) for processing.

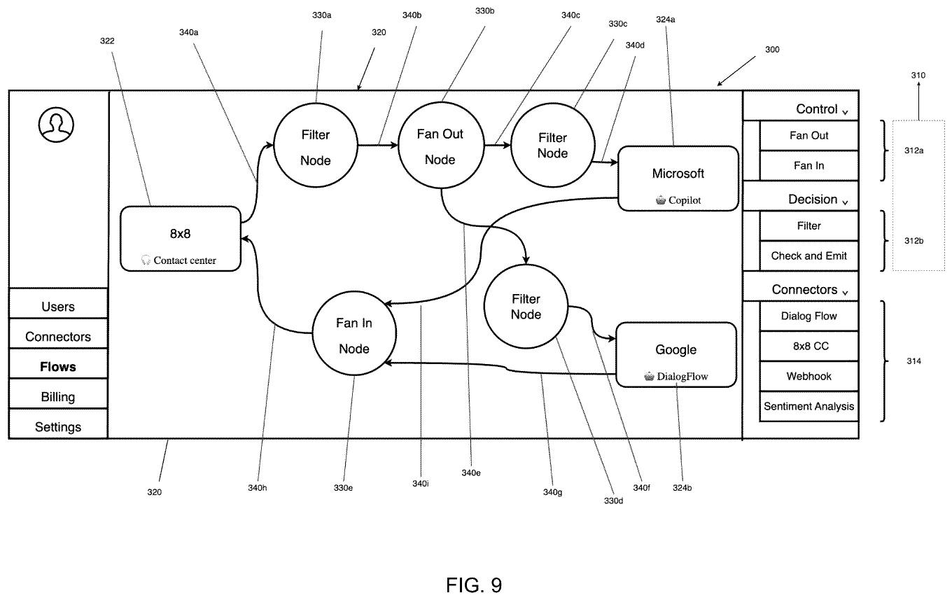

In the above examples, the data-flow diagram 320 is illustrated as having an entity object representing a chatbot or chatbot provider. In other cases, the data-flow diagram 320 may include multiple entity objects representing multiple chatbots or multiple chatbot providers. FIG. 9 illustrates another example of a data-flow diagram 320 created using the user interface 300. In the illustrated example, the created data-flow diagram 320 includes a first entity object 322 representing the contact center 20 or a component of the contact center 20. The created data-flow diagram 320 also includes a second entity object 324a representing a first chatbot or a first chatbot provider of the first chatbot, and a third entity object 324b representing a second chatbot or a second chatbot provider of the second chatbot. As shown in the figure, the data-flow diagram 320 further includes a first data-flow control object 330a that is a filter object representing a first filter, a second data-flow control object 330b that is a fan-out object, a third data-flow control object 330c that is a second filter object representing a second filter, a fourth data-flow control object 330d that is a third filter object representing a third filter, and a fifth data-flow control object 330e that is a fan-in object. In the data-flow diagram 320, a first arrow 340a connects an output of the first entity object 322 (representing the contact center 20 or a component of the contact center 20) to an input of the first data-flow control object 330a (first filter object), a second arrow 340b connects a first output of the first data-flow control object 330a to an input of the second data-flow control object 330b (fan-out object), a third arrow 340c connects a first output of the second data-flow control object 330b to an input of the third data-flow control object 330c (second filter object), and a fourth arrow 340d connects an output of the third data-flow control object 330c to the second entity object 340d (representing the first chatbot or first chatbot provider). Also, in the data-flow diagram 320, a fifth arrow 340e connects a second output of the second data-flow control object 330b (fan-out object) to an input of the fourth data-flow control object 330d (third filter object), and a sixth arrow 340f connects an output of the fourth data-flow control object 330d (third filter object) to an input of the third entity object 324b (representing the second chatbot or second chatbot provider). In the data-flow diagram 320, a seventh arrow 340g connects an output of the third entity object 324b (representing the second chatbot or second chatbot provider) to a first input of the fifth data-flow control object 330e (fan-in object), an eighth arrow 340h connects a first output of the fifth data-flow control object 330e to an input of the first entity object 322 (representing the contact center 20 or a component of the contact center 20), and a nineth arrow 340i connects an output of the second entity object 324a (representing the first chatbot or first chatbot provider) to a second input of the fifth data-flow control object 330e.

Accordingly, the data-flow diagram 320 of FIG. 9 represents a processing scheme to be executed, in which communication data received by the contact center 20 or a component of the contact center 20 (represented by the first entity object 322) is duplicated to obtain first communication data and second communication data (corresponding with the fan-out feature of the second data-flow control object 330b). The first communication data is passed to the filter (represented by the third data-flow control object 330c), and then to the first chatbot or first chatbot provider (represented by the second entity object 324a). The second communication data is passed to another filter (represented by the fourth data-flow control object 330d), and then to the second chatbot or second chatbot provider (represented by the third entity object 324b). Also, in the processing scheme, communication data from the first chatbot or first chatbot provider (represented by the second entity object 324a), and communication data from the second chatbot or second chatbot provider (represented by the third entity object 324b) are both passed to the contact center 20 or a component of the contact center 20 (represented by the first entity object 322) based on the fan-in object 330e in the data-flow diagram 320. Thus, customer messages received by the contact center 20 or a component of the contact center 20 are passed to the first chatbot and/or the second chatbot, depending whether they meet the filtering conditions at the filters (represented by filter objects 330c, 330d). For example, if the customer message is regarding the topic of traveling, then the message may be passed to the first chatbot 324a that is configured to handle traveling topics. As another example, if the customer message is regarding restaurant reservation, then the message may be passed to the second chatbot 324b that is configured to handle restaurant reservations.

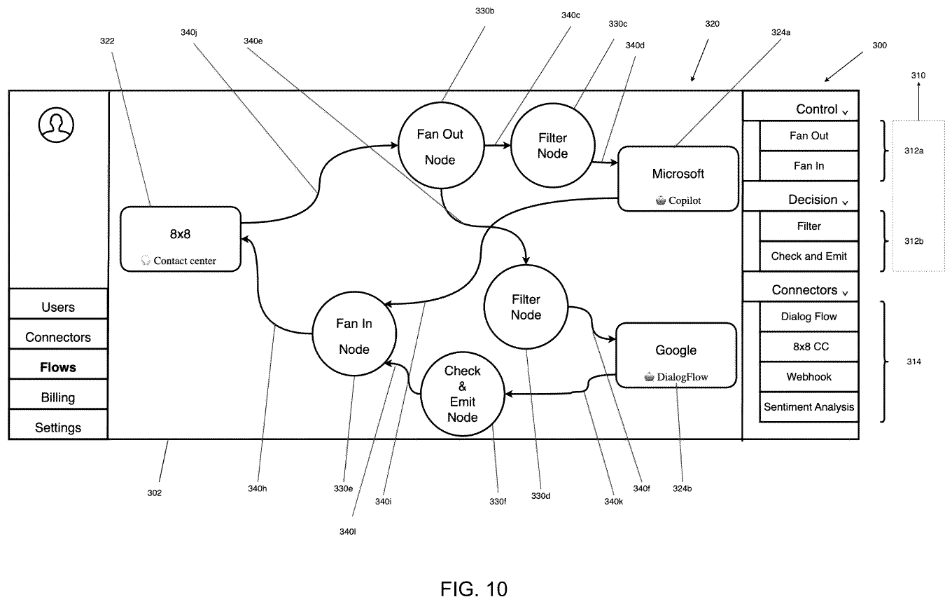

FIG. 10 illustrates another example of a data-flow diagram 320 created using the user interface 300. The data-flow diagram 320 of FIG. 10 is the same as the data-flow diagram 320 of FIG. 9, except that the data-flow diagram 320 of FIG. 10 does not include the data-flow control object 330a and the arrows 340a, 340b. Instead, in the data-flow diagram 320 of FIG. 10, an arrow 340j connects an output of the first entity object 322 (representing the contact center 20 or a component of the contact center 20) to an input of the data-flow control object 330b (fan-out object). Also, in the data-flow diagram 320 o FIG. 10, the arrow 340g in FIG. 9 is removed, and is replaced with data-flow control object 330f (check-and-emit object) and arrows 340k, 340l. The arrow 340k connects an output of the third entity object 324b (representing the second chatbot or second chatbot provider) to an input of the data-flow control object 330f, and the arrow 340l connects an output of the data-flow control object 330f to an input of the data-flow control object 330e (fan-in object). Thus, processing feature(s) may be added to, and/or removed from, the processing scheme easily using the user interface 300.

It should be noted that the data-flow diagram 320 that can be created using the user interface 300 is not limited to the above examples, and that the user interface 300 may be utilized by one or more users to create data-flow diagrams 320 having other configurations. For example, in other cases, the user interface 300 may be utilized to create a data-flow diagram 320 having more than two entity objects representing more than two chatbots or chatbot providers. This enables use of multiple chatbots in the same conversation. Also, in other cases, the user interface 300 may be utilized to create a data-flow diagram 320 having two or more entity objects representing respective contact centers. Accordingly, the data-flow diagram 320 may define a processing scheme involving one or more contact centers and one or more chatbots (or chatbot providers), thereby integrating the contact center(s) with the chatbot(s) (or chatbot providers). In some cases, the processing scheme implemented based on the data-flow diagram 320 may optionally involve a handoff between the chatbot and another chatbot, or between the chatbot and a human agent. Also, in some cases, the processing scheme implemented based on the data-flow diagram 320 may optionally involve a sentiment analysis to detect customer frustration or customer desire to communicate with a human agent.

During use, after the data-flow diagram 320 is created by the user, the user may save the created data-flow diagram 320 in the integration database 220. In some cases, the integration database 220 includes a database structure configured to store configuration data representing the created data-flow diagram 320. For example, the database structure may allow the integration database 220 to store configuration information indicating the objects (e.g., data-flow control object(s), entity object(s), arrow(s), etc.) used to create the data-flow diagram 320, and how the objects are connected.

After the data-flow diagram 320 is stored in the integration database 220, it may then be used to implement a processing scheme in a communication session. In the communication session, the communication interface 240 of the system 200 receives communication data transmitted between a customer and one or more chatbots. The integration engine 230 retrieves the configuration data of the data-flow diagram 320, and processes the communication data in accordance with the features of the data-flow diagram 320. The integration engine 230 may be directly or indirectly in communication with different processing entities represented by the different objects of the data-flow diagram 320. In some cases, a processing entity may be provided by a third-party that is not a part of the contact center 20. In other cases, a processing entity may be provided by the contact center 20. Based on the configuration of the data-flow diagram 320, the integration engine 230 then directs communication traffic to one or more processing entities, and coordinates output of different processing entities so that they are routed according to the data path dictated by the data-flow diagram 320.

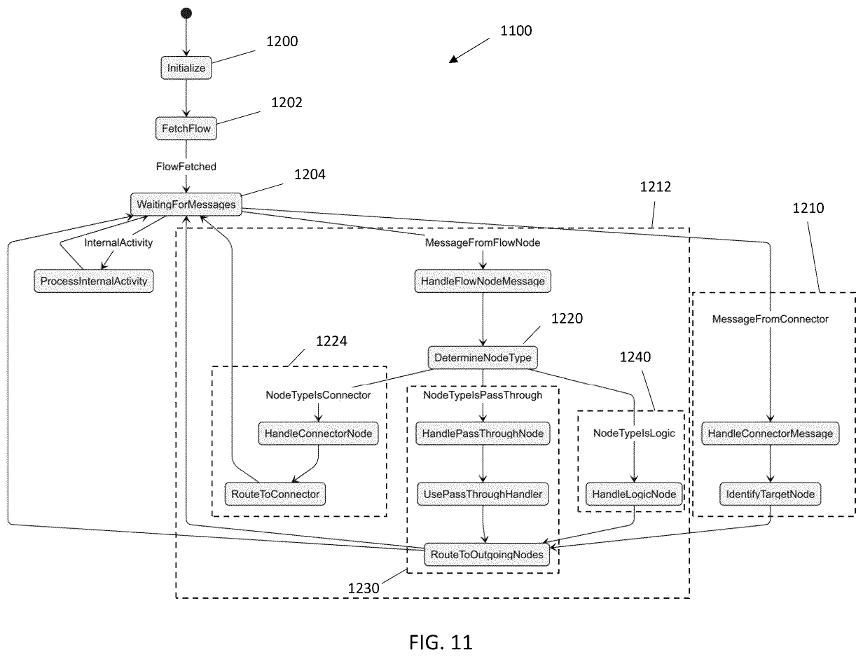

The integration engine 230 comprises logic configured to process configuration data of the data-flow diagram to cause the processing scheme to be physically executed by physical components of a communication system (e.g., communication system 10) in accordance with the data path represented by the data-flow diagram. FIG. 11 illustrates a state diagram 1100 for a session, which may represent an instance of a dataflow. At the beginning of the state diagram 1100, the integration engine 230 performs initialization (item 1200) and flow fetching (item 1202). In particular, the integration engine 230 starts a session using parameters such as session identifier and object identifier(s) (e.g., identifiers identifying entity objects and data-flow control objects in the data-flow diagram). The integration engine 230 then fetches the relevant flow configuration tied to the object identifiers in accordance with the data-flow diagram, dictating the message routing within the session. When a message comes in, the integration engine 230 then determines whether the message is from a connector node (e.g., from an entity object) or a flow node (e.g., from a data-flow control object) (item 1204). If the message comes from a connector (e.g., entity object), the integration engine 230 then processes the incoming message from the connector by identifying the target node in the flow configuration, and routing the message to the appropriate outgoing nodes based on the flow and connector-to-node mappings (item 1210). If the message comes from a flow node (e.g. data-flow control object), the integration engine 230 processes the message from flow node (item 1212). In particular, the integration engine 230 determines a type of the flow node (e.g., route-to-connector node, logic node, pass-through node, etc.), and directs the message downstream based on the type of the flow node (item 1220). For example, the integration engine 230 may direct the message to another connector, to an outgoing node, to a pass-through node, etc. For transmission of messages to connectors, the integration engine 230 directs the messages to connectors based on their predefined types, with each type linked to a specific handler module for processing and transmitting the message (item 1224). If the data flow involves a Pass-Through node, the integration engine 230 uses a specialized handler to process (and optionally to transform) the message before directing the message to the next node (item 1230). In some cases, there may be multiple handlers for performing different respective message processing. In such cases, the integration engine 230 may dynamically select one or more of the handlers based on the pass-through node type. If the data flow involves a logic node, the integration engine 230 uses a logic node handler to process the message before directing the message to the next node (item 1240). In the data-flow processing performed by the integration engine 230, messages are routed from one node to designated outgoing nodes per the flow configuration dictated by the data-flow diagram, ensuring each message reaches the correct subsequent node. Each node is aware of the flow it is part of. In some cases, a node may be a connector node (e.g., entity node representing an entity object) configured to manage incoming messages linked to a connector instance, which holds user-configured credentials for verifying and dispatching messages to and from external systems. Each message may be a part of an external conversation or session. In some cases, if a node receives a new message without an associated internal session, the integration engine 230 may create a session process, representing an instance of the flow. Also, in some cases, a connector node may reference an internal session and may create an external session or thread that associates with the internal session. It then uses the credentials and the external session details to dispatch the message to the external system. An external system may be a contact-center, a bot or bot provider, or any system that handles chat messages in a thread.

In some cases, the user interface 300 and/or the system 200 may be implemented using React's component-based architecture, which is suitable for building dynamic and response user interface. React's efficient update mechanism may be utilized to show conversation flow and/or topology changes in real-time, enhancing user experience. Also, React Flow may offer a flexible way to visualize and manipulate node-based architectures visually. Furthermore, Elixir programming language may be utilized to build highly concurrent, distributed, and resilient message-driven applications for the system 200. Elixir's actor model provides a high-level abstraction for building scalable applications. In addition, Elixir's support for building distributed systems may help the system 200 and/or the contact center 20 process chatbot conversations across different servers, maintaining consistency and performance.

As illustrated in the above examples, the system 200 described herein are advantageous, because the system 200 provides an extremely flexible integration layer that enables integration of one or more chatbots (from same and/or different chatbot providers) in the same data processing flow (e.g., a chatbot conversation) with the contact center(s). The system 200 provides fast integration with any chatbot providers, thereby reducing barriers including resources time/costs to integrate chatbots with the contact center 20. In some cases, a user may integrate a chatbot from a chatbot provider without requiring any or significant effort from the chatbot provider.

Also, the user interface 300 provided by the system 200 is advantageous. The user interface 300 provides a visual design editor for designing conversation flows, making it easier for users to visualize and configure the connections between nodes in the conversation flows, and also manage integration with different third-party entities. The user interface 300 is an intuitive graphical design interface that allows users with varying technical expertise to create and/or edit data-flow diagrams. In some cases, the system 200 may optionally also provide validation (e.g., real-time validation) and testing of the created data-flow diagram 320, which would significantly enhance the user experience. The created data-flow diagram 320 is adaptable for different process flow, and is easily scalable.

In addition, the user interface 300 provided by the system 200 is also advantageous because it allows users to create and define their own processing modules (custom nodes development). In some cases, a user may utilize the user interface 300 to define a customized node with custom logic and/or custom integration for a specific application that is new and unique. This empowers users to tailor the system precisely to their needs. In some cases, the contact center 20 may have its own technology partners, which are third-party entities offering their respective technological features. The contact center 20 may already integrate with third-party APIs, third-party databases, third-party components, or any combination of the foregoing, of these technology partners. Through these technology partners, the contact center 20 may offer technological features (e.g., cloud-based solutions and functions) to extend platform capabilities. As such, a user may utilize the user interface 300 to create customized modules and nodes, which integrate one or more of these third-party features or functionalities to create customized nodes. Accordingly, the user interface 300 provides users with the ability to leverage the contact center's expansive data across its platform to create improved integrated process flows, thereby achieving better interactions between customers and chatbot(s) (especially when leveraging multiple different chatbots in one customer experience).

As illustrated in the above examples, the user interface 300 is also advantageous because it can be utilized to create new functionalities (e.g., by combining different types of data-flow control objects and entity objects representing different entities providing different technological features) not currently existing in data-flows. By means of non-limiting examples, the processing scheme for processing communication between a customer and chatbots may include sentiment analysis for gauging customer sentiment throughout conversation, authentication, biometric analysis, generative AI, chat attachments and adaptive cards to present richer communication and contextual analysis (historical and/or current), or any combination of two or more of the foregoing. Thus, the system 200 described herein can enhance the capabilities of existing chatbots, which may result in quicker replies and/or improved accuracy.

In some cases, the system 200 is not limited to integrating the contact center 20 (or a component of the contact center 20) with chatbot provider(s), and may be utilized by other contact center(s) to connect with one or more chatbots, enhancing the services of the other contact center(s). In addition, chatbot providers that do not offer a contact center solution may provide a handover feature to their customers through the system 200.

Also, in some cases, due to its integration with its partners, and due to its handling of communication data between many different entities, the contact center 20 may handle and manage a large amount of data and data endpoints. The system 200 may leverage such data to create contextually relevant workflows. In particular, the system 200 may access data repositories storing such data, and may utilize such data to create customized workflows, create templates for new workflows, etc.

Furthermore, in some cases, different users of the system 200 may share their custom nodes, templates, or data-flow diagrams. This will create a community-driven marketplace, and will foster a vibrant ecosystem at or around the contact center 20, encouraging user innovation and collaboration.

### Method

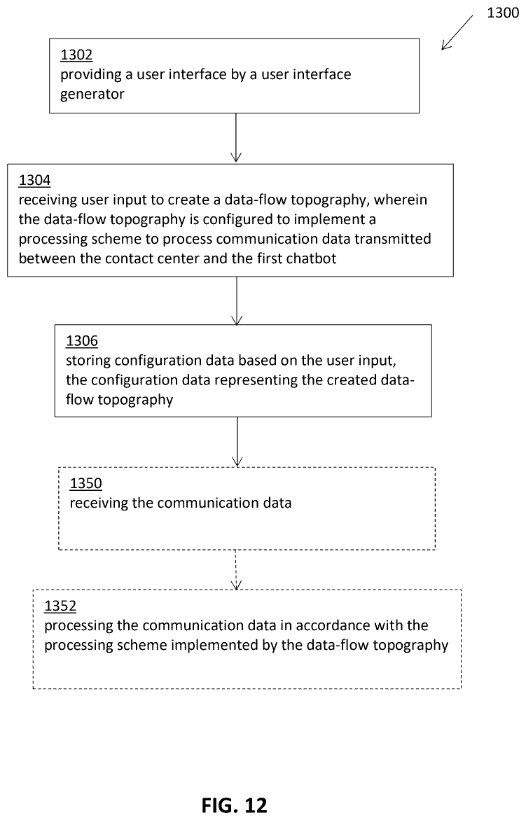

FIG. 12 illustrates a method 1300 in accordance with some embodiments. The method 1300 involves one or more chatbots comprising a first chatbot and a contact center, and includes: providing a user interface by a user interface generator (item 1302); receiving user input to create a data-flow diagram, wherein the data-flow diagram is configured to implement a processing scheme to process communication data transmitted between the contact center and the first chatbot (item 1304); and storing configuration data based on the user input, the configuration data representing the created data-flow diagram (item 1306).

Optionally, the method 1300 further comprises: receiving the communication data (item 1350); and processing the communication data in accordance with the processing scheme implemented based on the data-flow diagram (item 1352).

Optionally, in the method 1300, the user interface comprises a first set of one or more data-flow control objects for selection by the user, and a second set of one or more entity objects for selection by the user.

Optionally, in the method 1300, the one or more data-flow control objects comprise a first data-flow control object configured to implement data-flow control for the processing scheme.

Optionally, in the method 1300, the one or more entity objects comprise a first entity object representing a first chatbot.

Optionally, in the method 1300, the data-flow diagram is configured to enable the contact center to process the communication data transmitted between the contact center and the first chatbot in accordance with the processing scheme based on the created data-flow diagram.

Optionally, in the method 1300, the one or more data-flow control objects comprise a second data-flow control object, and wherein the user interface is configured to allow the user to create a data path for the data-flow diagram, the data path connecting the first data-flow control object to the second data-flow control object, or to the first entity object.

Optionally, in the method 1300, the data-flow diagram is configured to integrate the one or more chatbots with the contact center.

Optionally, in the method 1300, the data-flow diagram is configured to integrate the one or more chatbots with another contact center.

Optionally, in the method 1300, the user interface comprises a display area configured to display a topography image representing the data-flow diagram, and wherein the first entity object is moveable in the display area.

Optionally, in the method 1300, the one or more entity objects comprise a second entity object representing a second chatbot.

Optionally, in the method 1300, the first chatbot and the second chatbot are associated with a same chatbot provider, or with different respective chatbot providers.

Optionally, in the method 1300, the one or more entity objects comprise a second entity object representing at least a part of the contact center.

Optionally, in the method 1300, the one or more entity objects comprises a second entity object representing an analytic tool or a processing tool.

Optionally, in the method 1300, the first data-flow control object comprises a fan-out object having an input node and two or more output nodes.

Optionally, in the method 1300, the first data-flow control object comprises a fan-in object having two or more input nodes and an output node.

Optionally, in the method 1300, the first data-flow control object comprises a filter object implementing a filter that filters at least some of the communication data in response to a satisfaction of one or more criteria.

Optionally, in the method 1300, the first data-flow control object comprises a check-and-emit object.

Optionally, in the method 1300, the processing scheme implemented based on the data-flow diagram involves a handoff between the first chatbot and another chatbot, or between the first chatbot and a human agent.

Optionally, in the method 1300, the processing scheme implemented based on the data-flow diagram involves a sentiment analysis to detect customer frustration or customer desire to communicate with a human agent.

Optionally, in the method 1300, the user interface is configured to access a configuration interface from a chatbot provider to allow the user to create and/or to configure the first chatbot during a process to create the data-flow diagram.

Optionally, in the method 1300, the user interface is configured to access another configuration interface from another chatbot provider to allow the user to create and/or to configure a second chatbot during the process to create the data-flow diagram.

Optionally, the method 1300 may be implemented using a product having a non-transitory medium storing a set of instructions, wherein an execution of the instructions will cause the method to be performed. The method 1300 implemented using the product may involve one or more chatbots comprising a first chatbot and a contact center, wherein the method includes: providing a user interface by a user interface generator; receiving user input to create a data-flow diagram, wherein the data-flow diagram is configured to implement a processing scheme to process communication data transmitted between the contact center and the first chatbot; and storing configuration data based on the user input, the configuration data representing the created data-flow diagram.

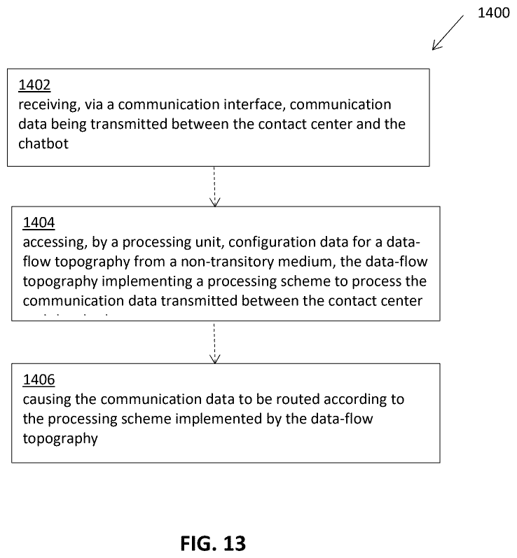

FIG. 13 illustrates another method 1400 in accordance with some embodiments. A method 1400 involves a chatbot and a contact center, and includes:
receiving, via a communication interface, communication data being transmitted between the contact center and the chatbot (item 1402); accessing, by a processing unit, configuration data for a data-flow diagram from a non-transitory medium, the data-flow diagram implementing a processing scheme to process the communication data transmitted between the contact center and the chatbot (item 1404); and causing the communication data to be routed according to the processing scheme implemented based on the data-flow diagram (item 1406).

Optionally, in the method 1400, the configuration data represents a directed acyclic graph (DAG), wherein the data-flow diagram corresponds with the DAG.

Optionally, in the method 1400, the data-flow diagram comprises a fan-in-node, a fan-out node, a filtering node, a check-and-emit node, an update state node, or any combination of two or more of the foregoing.

Optionally, the method 1400 further includes converting the communication data to a standardized format, wherein the standardized format comprises a routing format, a chat format, an attachment format, an adaptive card format, or a data event format.

Optionally, the method 1400 further includes evaluating the communication data using a check-and-emit node, and wherein the check-and-emit node is configured to evaluate the communication data to determine whether a condition is satisfied, and to emit an event if the condition is satisfied.

Optionally, in the method 1400, the processing scheme implemented based on the data-flow diagram involves a handoff between the chatbot and another chatbot, or between the first chatbot and a human agent.

Optionally, in the method 1400, the processing scheme implemented based on the data-flow diagram involves a sentiment analysis to detect customer frustration or customer desire to communicate with a human agent.

Optionally, the method 1400 is performed by a system that is a part of an orchestration layer configured to manage interaction between the chatbot and on-premise component(s) of the contact center.

Optionally, the method 1400 is performed by a system that is a part of the data center, or is communicatively coupled with a component of the data center.

Optionally, the method 1400 further includes: providing, by a user interface generator, a user interface for allowing a user to create the data-flow diagram implementing the processing scheme to process the communication data transmitted between the contact center and the chatbot; wherein the user interface comprises a first set of one or more data-flow control objects for selection by the user, and a second set of one or more entity objects for selection by the user; wherein the one or more data-flow control objects comprise a first data-flow control object configured to implement data-flow control for the processing scheme; wherein the one or more entity objects comprise a first entity object representing the chatbot; and wherein the data-flow diagram is configured to enable the contact center to process the communication data transmitted between the contact center and the chatbot in accordance with the processing scheme.

Optionally, the method 1400 may be implemented using a product having a non-transitory medium storing a set of instructions, wherein an execution of the instructions will cause the method to be performed. The method 1400 implemented using the product may involve a chatbot and a contact center, and includes: receiving, via a communication interface, communication data being transmitted between the contact center and the chatbot; accessing, by a processing unit, configuration data for a data-flow diagram from a non-transitory medium, the data-flow diagram implementing a processing scheme to process the communication data transmitted between the contact center and the chatbot; and causing the communication data to be routed according to the processing scheme implemented based on the data-flow diagram.

### Specialized Processing System

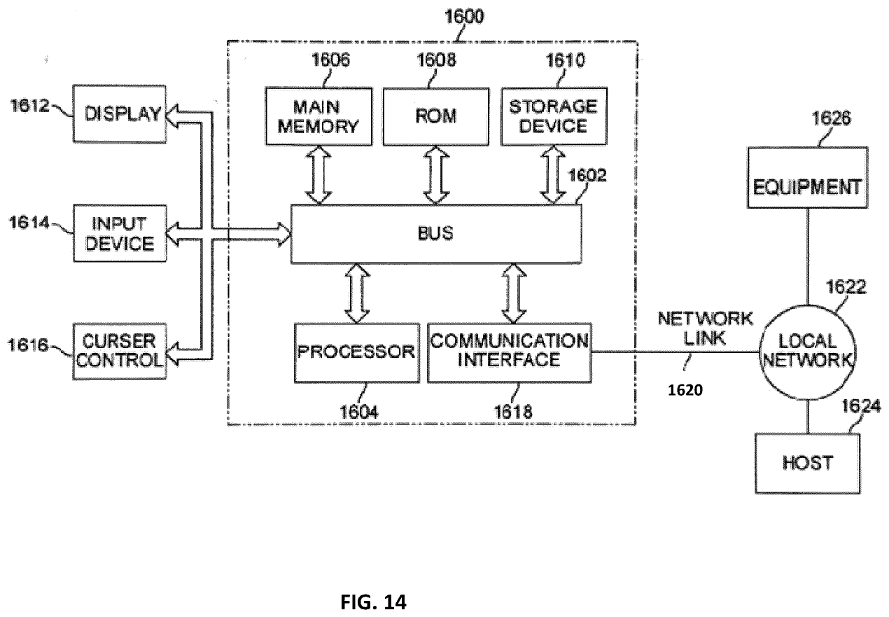

FIG. 14 illustrates a specialized processing system 1600 for implementing one or more features described herein. For examples, the processing system 1600 may implement the system 200, or one or more components of the system 200.

Processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processor system 1600 may be coupled via the bus 1602 to a display 1612, such as a screen or a flat panel, for displaying information to a user. An input device 1614, including alphanumeric and other keys, or a touchscreen, and/or any of other data capture devices (sensors), is coupled to the bus 1602 for communicating information and command selections to processor 1604. Another type of user input device is cursor control 1616, such as a 2D touchpad, a touchscreen, a trackball, or cursor direction keys for communicating direction information and command selections to processor 1604 and/or for controlling cursor movement on display 1612. This input device typically has two degrees of freedom in two axes, a first axis (e.g., x) and a second axis (e.g., y), that allows the device to specify positions in a plane. The input device 1614 and/or the cursor control device 1616 may be the same device in some embodiments. Also, the input device 1614 and/or the cursor control device 1616 may be any 2D input device or 3D input device.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, SD disks, such as the storage device 1610. A non-volatile medium may be considered an example of non-transitory medium. Volatile media includes dynamic memory, such as the main memory 1606. A volatile medium may be considered an example of non-transitory medium. Transmission media includes cables, wire and fiber optics, including the wires that comprise the bus 1602. Transmission media can also take the form of acoustic or light waves, such as those generated during radio wave and infrared data communications.

Common forms of processor-readable media include, for example, hard disk, a magnetic medium, a CD-ROM, any other optical medium, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a storage of a remote computer or remote device. The remote computer or device can send the instructions over a network, such as the Internet. A receiving unit local to the processing system 1600 can receive the data from the network, and provide the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card to provide a data communication. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

In some cases, the processing system 1600 may be configured as a specialized processing system using instructions and/or programming language to cause electronic components of the processing system 1600 to behave in certain unique manner in order to provide one or more technical features described herein.

Also, in some cases, one or more of the actions (e.g., receiving, providing, processing, etc.) described herein as being performed by the system 200 are performed electronically. Therefore, they are not mental process and are not abstract idea. In addition, the data-flow diagram 320 created using the user interface 300 results in physical transformation in the real world. This is because it is configured to cause communication data to be routed in specific way to one or more processing entities, which will otherwise not occur.

### Neural Network Implementation

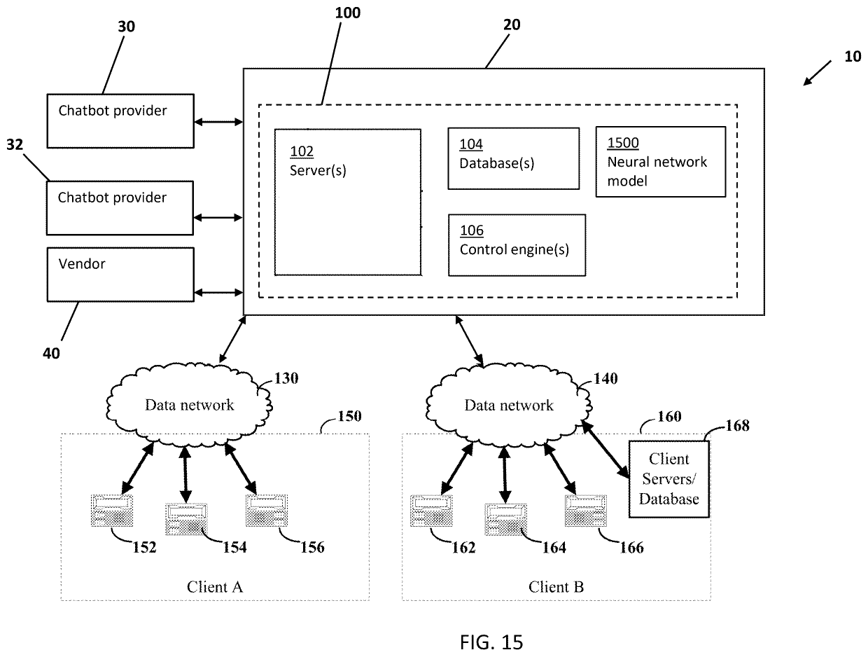

Moreover, aspects of the present disclosure are directed to systems and methods that implement neural network model. FIG. 15 illustrates a communication system 10 that is the same as that described with reference to FIG. 1, particularly showing the processing system 100 having a neural network model 1500. By means of non-limiting examples, the neural network model 1500 may be trained artificial intelligence (AI), machine learning (ML), etc. The neural network model 1500 may implement, or may be at least a part of the integrator 110. In some cases, one or more of the components 210, 220, 230, 240, 250, 252, 254 of the system 200 may be implemented using, or may include, a neural network model, such as the neural network model 1500.

In some cases, the neural network model 1500 may provide neural network processing to further contemplate various types of signal data that may be collected through various host applications/services (e.g., pertaining to a software communications platform). For instance, application of trained AI/ML processing (e.g., one or more trained machine learning models) may be adapted to evaluate data sources integrated into an exemplary software platform (e.g., software communications platform such as 8×8 Work®), omni-channel orchestration of data points that include native data sources as well integrated third-party endpoints (e.g., third-party integrations including CRM tools). Contextual data can be derived from any data point individually or in aggregation including historical signal data or current signal data (e.g., an ongoing communication such as an electronic meeting). For example, historical signal data collected using a software communications platform, including from prior user communications, can be combined with current user-specific signal data, device-specific signal data, etc., prior, during or after an electronic communication (e.g., chatbot interaction), to generate and surface contextually relevant data insights for a user (e.g., agent assisting a customer and/or in different omni-channel communication experiences across a software communications platform). This unique and comprehensive analysis of big data managed through a software communications platform enables provision of rich and contextually relevant data insights tailored for a specific purpose (e.g., enhance user communication and abilities of agents in communications with customers) and further contextual data that can be leveraged to improve back-end data processing and real-time (near real-time) operation of applications/services including GUI features/functionalities presented to users of application/services, software communications platforms, etc. Exemplary signal data analysis can further be utilized to yield determinations as to how (and/or when) to generate updated analytics (in real-time or near real-time) and/or reporting, as well as when and how often to present data insights and/or suggestions. For example, it is important to properly evaluate a state of communication and identify contextually relevant data within an ongoing communication (e.g., dependent on user's sentiment, topic of conversation, content being presented, user attendance, etc.) relative to historical data and/or predicted patterns of users, which may help to determine not only the correct data to surface but when that data would be most beneficial to users. In further examples, signal data can be analyzed to determine the next steps or actions to be performed to continue communication and user engagement across a plurality of communication channels of a software communications platform (e.g., omni-channel communication experience). As non-limiting examples, this may include automatically taking action to include other users in a communication, sentiment analysis, summarization, setting reminders, follow-up meetings, etc. communicating contextual data representations to agents, support staff pertaining to customer interactions, feedback, etc. Non-limiting examples of signal data that may be collected and analyzed includes but is not limited to: device-specific signal data collected from operation of one or more user computing devices; user-specific signal data collected from specific tenants/user-accounts with respect to access to any of: devices, login to a distributed software platform, applications, services, etc.; application-specific data collected from usage of applications/services and associated endpoints (including third-party endpoints integrated within a software platform), data collected from disparate software platforms that provide disparate types of access characteristics; data collected from data flow architecture including integrated bots in a software communications platform, or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., software communications platforms) whether the target users are developers/engineers, end users/customers, where telemetric analysis may be applied to generate determinations with respect to a contextual state of any type of user activity with respect to different host application/services and associated endpoints at any point in time (historic, current, or predictive of future). Analysis of signal data, including user-specific signal data, should occur in compliance with user privacy regulations and policies.

In some examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI, ML modeling. Trained AI processing may be adapted to execute specific determinations described herein including those for analyzing specific data and data sources of a software data platform (e.g., a software communications platform) and/or generating insights for management of data flows, GUI feature functionality, or data augmentation. For instance, an AI model may be specifically trained and adapted for execution of processing operations pertaining to analyzing features and functionality of a software communications platform including those non-limiting examples described herein. Non-limiting examples of AI implementation including but are not limited to: analyzing data (and metadata) associated with one or more software platforms including third-party integrations of features/functionalities; analyzing data of past, current or scheduled communications, among other examples.

In one example, trained AI processing comprises a hybrid AI model (e.g., hybrid machine learning model, neural network model) that is adapted and trained to execute a plurality of processing operations described in the present disclosure. In alternative examples, trained AI processing comprises a collective application of a plurality of trained AI models (e.g., 3 trained AI models) that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to work within a software communications platform including data, data sources, and integrations (e.g., APIs, web hooks, etc.) related to features and functionality provided (or extending capabilities) of a software communications platform. In examples where a plurality of independently trained and managed AI models is implemented, downstream processing efficiency may be improved by an ordered application of trained AI models where processing results from earlier applied AI models can be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise but are not limited to: nearest neighbor processing; naive Bayes classification processing; decision trees; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, etc.; application of association rule learning; application of latent variable modeling; anomaly detection; and neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise but are not limited to: value-based processing; policy-based processing; and model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI/ML processing.

Further, aspects may integrate AI/ML modeling to correlate large volumes of data in a contextually relevant manner. This can be used not only for generation (and adaptation) of scoring for types of data to surface but also generation of decision points (e.g., alerting, access control, next steps, omni-channel engagement) as well as generation of data insights/suggestions, reporting, generation of knowledge base, support content, data processing flow configuration recommendations. In addition to broad applicability, approaches according to the present disclosure can be implemented as a scalable solution (e.g., a solution for a company in several different use cases are built (such as department-specific or user group-specific) to more effectively manage a software platform (e.g. communications software platform).

As an example, one or more ML/AI models may be generated, trained and adapted to analyze context of chatbot interactions, for example, to identify sticking points and issues that may persist in a current configuration and data processing flow in an exemplary data orchestration layer. For instance, one integrated chatbot may be configured to manage topics of travel while another chatbot may be configured to handle sentiment analysis. Through analyzing data points of a conversation between a user and service, it can be detected that a user is frustrated with the first chatbot (topics of travel) in that the chatbot wasn't properly assisted with booking of dinner reservations in a selected travel location. This data point, among others, can be determined and fed back to the developers to consider reviewing and modifying the data processing flow, including potential integration of additional bots into an exemplary data orchestration layer, to resolve potential points of frustration for an end user.

In further examples, the AI/ML modeling (or separate additional modeling combined therewith can be adapted) may further analyze additional endpoints of a software communications platform to provide richer, contextual, and cross-functional insights for management of data processing (e.g., in data orchestration layers) or user/customer management. For instance, AI modeling may be applied to analyze a chatbot query and conversation further in the context of other data points across a software communications platform (e.g., chat, messaging, emails, meetings, recordings, CRM data, etc.) to generate persistent data insights application cross-platform to better manage an overall user experience. Continuing the above example regarding dinner reservations, patterns of analysis performed by the adapted AI/ML modeling may learn that this is the third time that the same user has had an issue with this chat. Such information may be passed on to customer agents, success managers, etc. to help improve an overall customer experience. In further examples, insights may be generated from such contextual analysis and/or suggestions for remediation which can be presented through a GUI to an agent or user. Moreover, suggested messages may even be generated and surfaced to end users directly (e.g., we know you have had multiple issues with this chatbot, and it must be frustrating, here is how we can address). This can further utilize and expand omni-channel communication capabilities of a software communications platform to build a truly customized and personalized user experience. Additionally, it provides an avenue for end users (e.g., customers) to provide feedback directly on specific features/functionalities (including pain points) that can then be directed to the engineers and product managers for re-evaluation of data flow and data processing (e.g., via data orchestration layers).

In additional examples, AI/ML modeling may be built, trained, and adapted to manage insight generation and layers of abstraction including ranking and relevance. For instance, contextual analysis of data interactions relative to the plurality of data endpoints for an exemplary software communications platform can selectively generate insights specific to interested parties such as product/engineering, data insights that are specific to end users, and data insights, that are specific to others including third-party vendors (e.g., who may integrate with a software communications platform). Generated insights can be ranked for relevance and propagated accordingly for one or more interested parties, for example, aligning with organizational specifications. For example, in some cases, an insight may be generated for product/engineering to address a potential issue with a bot data processing flow that has relevance to a third-party vendor integration (e.g., for that chatbot). In such cases, the product/engineering team may want to sync with that third-party vendor to address the potential issue. Depending on their organizational desires, AI/ML modeling may be used to generate a corresponding data insight for that third-party vendor, associated with the data insight generated for product/engineering, which can foster efficiency in issue communication and remediation in a processing data flow. In other examples, engineering may wish leverage such data insights to automatically raise a support ticket (internally and/or via a third-party vendor) to address data integration issues, among other possible actions.

### Cloud-Based Platform Implementation

It should be noted that the system 200 and/or the contact center 20 described herein may be implemented as, or may be a part of, any platform(s), such as one or more cloud-based platforms. By means of non-limiting examples, the one or more cloud-based platforms may include an Unified Communications as a Service (UCaas) platform, a Control Center as a Service (CCaas) platform, a Communications Platform as a Service (CPaas), or any combination of two or more of the foregoing.

UCaaS is a cloud-based solution that integrates various communication tools and services, including voice calls, video conferencing, messaging, and collaboration features into a single platform. It aims to simplify and unify communications within an organization, enabling employees to connect seamlessly across different devices and locations. UCaaS platforms may provide tools for voice over IP (VoIP), instant messaging, file sharing, video calls, and even presence management. By leveraging the cloud, businesses can scale their communication infrastructure without needing on-premise hardware, and remote or hybrid teams can communicate as easily as if they were in the same office.

CCaaS refers to a cloud-based platform that provides businesses with the tools to manage and optimize their customer service and support operations. It may include features like automatic call distribution (ACD), interactive voice response (IVR), call recording, omnichannel support (electronic meetings, voice, chat, email, messaging, digital messaging, social media), and analytics. CCaaS solutions are designed to improve customer experiences by streamlining communication with support agents and offering deeper insights into customer interactions. They also allow organizations to scale their contact centers efficiently, adapting to peak periods or shifting team sizes. This service is particularly beneficial for businesses with high customer interaction volumes, such as retail, finance, and telecom.

CPaaS is a cloud-based service that provides developers with the tools and APIs to integrate real-time communication capabilities into their own applications, websites, or workflows. Unlike UCaaS and CCaaS, which are pre-built solutions, CPaaS offers a flexible, customizable platform that can be tailored to the specific needs of an organization. With CPaaS, businesses can embed voice, video, messaging, and even chatbots into their applications without having to build complex communication infrastructure from scratch. This makes CPaaS ideal for organizations looking to create bespoke customer engagement solutions or integrate communication features into existing platforms, such as e-commerce websites or CRM systems.

In other cases, the system 200 and/or the contact center 20 described herein may be implemented as, or may be a part of, other types of cloud-based platforms, such as a Customer Experience as a Service (CXaaS) platform, an Infrastructure-as-a-Service (IaaS) platform, Platform-as-a-Service (PaaS), a Software-as-a-Service (SaaS) platform, or Anything-as-a-Service (xPaas) platform.

CXaaS is a cloud-based model that provides businesses with on-demand tools and services to manage and enhance their customer experience (CX) across various touchpoints. It integrates a wide range of solutions—such as customer service platforms, analytics, feedback management, and communication channels—into a unified service offering. CXaaS allows organizations to deliver personalized, omnichannel experiences for customers without having to invest in complex, on-premise systems. By leveraging cloud technology, businesses can easily scale their CX capabilities, gain insights from data analytics, and continuously improve interactions with customers, ultimately boosting satisfaction and loyalty. CXaaS empowers companies to respond more agilely to changing customer expectations while reducing the overhead of maintaining and upgrading traditional customer experience infrastructure.

IaaS is a cloud computing model that provides virtualized computing resources over the internet, such as servers, storage, networking, and other infrastructure components, on a pay-as-you-go basis. Instead of investing in and maintaining physical hardware, businesses can rent infrastructure from a cloud service provider, allowing them to scale resources up or down based on demand. IaaS offers flexibility, cost-efficiency, and the ability to focus on application development and business operations rather than IT management. With IaaS, businesses can deploy and manage applications without the need for physical data centers, significantly reducing capital expenditures and operational complexity.

PaaS is a cloud computing model that provides a comprehensive platform allowing developers to build, deploy, and manage applications without needing to manage the underlying infrastructure. It offers a set of tools, frameworks, and services—such as databases, development environments, and middleware—built on top of IaaS (Infrastructure-as-a-Service), enabling businesses to focus on writing code and developing functionality rather than worrying about the hardware, network, or operating system. PaaS platforms typically support multiple programming languages and integrate with various third-party services, allowing for greater flexibility and speed in application development. By abstracting away infrastructure concerns, PaaS empowers developers to innovate and scale applications quickly, improving productivity and reducing time-to-market for new features or products.

SaaS is a cloud computing model that delivers software applications over the internet on a subscription or pay-as-you-go basis, eliminating the need for businesses to install, maintain, or update software on their own servers or devices. With SaaS, users can access applications from any device with an internet connection, typically through a web browser, making it highly convenient and scalable. SaaS providers handle all aspects of the software, including updates, security, and infrastructure management, freeing businesses from the complexities of software maintenance. This model is particularly advantageous for businesses because it reduces upfront costs, supports remote collaboration, and ensures that users are always using the most up-to-date version of the software.

xPaaS is an expansive cloud service model that offers a wide range of customizable, on-demand capabilities across various domains, such as infrastructure, software, and platforms, enabling businesses to access specialized services without the need for extensive on-site management. Unlike traditional cloud models like IaaS, PaaS, or SaaS, xPaaS can encompass almost any type of service or functionality a business may require, from data analytics and artificial intelligence to security, IoT, and application deployment. This flexibility allows organizations to tailor solutions to their unique needs, scale resources dynamically, and innovate faster while minimizing upfront costs and complexity. xPaaS simplifies operations by providing a unified, cloud-based platform for diverse business functions, making it an appealing option for organizations seeking agility and cost efficiency in a rapidly changing digital landscape.

### Definitions

As used in this specification, the term “product” may refer to any human-made and/or machine-made article/item. By means of non-limiting examples, the product may be an electronic device, a hardware and/or software component of an electronic device, an application in a cloud/server, etc.

As used in this specification, the term “chatbot” refers to any processing unit or component thereof that is configured to communicate with a person, such as by messaging, voice, etc. In some embodiments, the chatbot may be a communication module of a processing unit, and the communication module may be implemented using hardware, software, or a combination of both.

As used in this specification, the term “contact center” refers to any communication system or component(s) thereof, which handles communications between or among parties via phone, SMS, email, web, cloud, social media, or any combination of the foregoing, wherein a party may be a customer, an organization, a chatbot, or any of other types of entity that is capable of communicating with an individual.

In addition, as used in this specification, the term “neural network model” refers to any computing unit, system, or module made up of a number of interconnected processing elements, which process information by their dynamic state response to input. In some embodiments, the neural network model may have deep learning capability, machine learning capability, and/or artificial intelligence. In some embodiments, the neural network model may be simply any computing element that can be trained using one or more data sets. Also, in some embodiments, the neural network model may be any type of neural network. By means of non-limiting examples, the neural network model may be a perceptron, a feedforward neural network, a radial basis neural network, a deep-feed forward neural network, a recurrent neural network, a long/short term memory neural network, a gated recurrent unit, an auto encoder neural network, a variational auto encoder neural network, a denoising auto encoder neural network, a sparse auto encoder neural network, a Markov chain neural network, a Hopfield neural network, a Boltzmann machine, a restricted Boltzmann machine, a deep belief network, a convolutional network, a deconvolutional network, a deep convolutional inverse graphics network, a generative adversarial network, a liquid state machine, an extreme learning machine, an echo state network, a deep residual network, a Kohonen network, a support vector machine, a neural turing machine, a modular neural network, a sequence-to-sequence model, etc., or any combination of the foregoing.

Furthermore, as used in this specification, the term “image” is not limited to an image that is displayed, and may refer to an image that is displayed or not displayed (e.g., an image in data or digital form that is stored).

In addition, as used in this specification, the term “model” may refer to one or more algorithms, one or more equations, one or more processing applications, one or more variables, one or more criteria, one or more parameters, or any combination of two or more of the foregoing. Also, the term “model” may in some embodiments cover machine learning model (such as neural network model), or components thereof, such as layers, interconnections weights, or any combination of the foregoing.

Also, as used in this specification, the term “machine learning model” may refer to any processing entity (e.g., module, application, program, processing architecture, etc.) that has machine learning capability and/or that is configured by machine learning. Neural network model is an example of machine learning model, and therefore, the term “machine learning model” is not limited to neural network model.

Also, as used in this specification, the term “signal” may refer to one or more signals. By means of non-limiting examples, a signal may include one or more data, one or more information, one or more signal values, one or more discrete values, etc.

The following items pertains to one or more embodiments or features described herein:
Item 1. A system for integrating one or more chatbots with a contact center, the one or more chatbots comprising a first chatbot, the system comprising:
   a user interface generator configured to provide a user interface for allowing a user to create a data-flow diagram implementing a processing scheme to process communication data transmitted between the contact center and the first chatbot;
   wherein the user interface comprises a first set of one or more data-flow control objects for selection by the user, and a second set of one or more entity objects for selection by the user;
   wherein the one or more data-flow control objects comprise a first data-flow control object configured to implement data-flow control for the processing scheme;
   wherein the one or more entity objects comprise a first entity object representing a first chatbot; and
   wherein the system is configured to enable the contact center to process the communication data transmitted between the contact center and the first chatbot in accordance with the processing scheme based on the created data-flow diagram.
Item 2. The system of Item 1, wherein the one or more data-flow control objects comprise a second data-flow control object, and wherein the user interface is configured to allow the user to create a data path for the data-flow diagram, the data path connecting the first data-flow control object to the second data-flow control object, or to the first entity object.
Item 3. The system of Item 1, wherein the system is configured to integrate the one or more chatbots with another contact center.
Item 4. The system of Item 1, wherein the user interface comprises a display area configured to display a topography image representing the data-flow diagram, and wherein the first entity object is moveable in the display area.
Item 5. The system of Item 1, wherein the one or more entity objects comprise a second entity object representing a second chatbot.
Item 6. The system of Item 5, wherein the first chatbot and the second chatbot are associated with a same chatbot provider, or with different respective chatbot providers.
Item 7. The system of Item 1, wherein the one or more entity objects comprise a second entity object representing at least a part of the contact center.
Item 8. The system of Item 1, wherein the one or more entity objects comprises a second entity object representing an analytic tool or a processing tool.
Item 9. The system of Item 1, wherein the first data-flow control object comprises a fan-out object having an input node and two or more output nodes.
Item 10. The system of Item 1, wherein the first data-flow control object comprises a fan-in object having two or more input nodes and an output node.
Item 11. The system of Item 1, wherein the first data-flow control object comprises a filter object implementing a filter that filters at least some of the communication data in response to a satisfaction of one or more criteria.
Item 12. The system of Item 1, wherein the first data-flow control object comprises a check-and-emit object.
Item 13. The system of Item 1, wherein the processing scheme implemented based on the data-flow diagram involves a handoff between the first chatbot and another chatbot, or between the first chatbot and a human agent.
Item 14. The system of Item 1, wherein the processing scheme implemented based on the data-flow diagram involves a sentiment analysis to detect customer frustration or customer desire to communicate with a human agent.
Item 15. The system of Item 1, wherein the user interface is configured to access a configuration interface from a chatbot provider to allow the user to create and/or to configure the first chatbot during a process to create the data-flow diagram.
Item 16. The system of Item 15, wherein the user interface is configured to access another configuration interface from another chatbot provider to allow the user to create and/or to configure a second chatbot during the process to create the data-flow diagram.
Item 17. The system of Item 1, wherein the system is a part of the data center or is communicatively coupled with the data center, and wherein the data center is configured to:
receive the communication data; and
process the communication data, in accordance with the communication scheme implemented based on the data-flow diagram.
Item 18. A method involving one or more chatbots and a contact center, the one or more chatbots comprising a first chatbot, the method comprising:
providing a user interface by a user interface generator;
receiving user input to create a data-flow diagram, wherein the data-flow diagram is configured to implement a processing scheme to process communication data transmitted between the contact center and the first chatbot; and
storing configuration data based on the user input, the configuration data representing the created data-flow diagram.
Item 19. The method of Item 18, wherein the method further comprises:
receiving the communication data; and
processing the communication data in accordance with the processing scheme implemented based on the data-flow diagram.
Item 20. A product having a non-transitory medium storing a set of instructions, wherein an execution of the instructions will cause the method of Item 18 to be performed.
Item 21. A system configured to integrate a contact center with a chatbot provided by a chatbot provider, the system comprising:
a communication interface configured to receive communication data being transmitted between the contact center and the chatbot;
a non-transitory medium storing configuration data regarding a data-flow diagram, the data-flow diagram implementing a processing scheme to process the communication data transmitted between the contact center and the chatbot; and
a processing unit configured to access the configuration data regarding the data-flow diagram, and to cause the communication data to be routed according to the processing scheme implemented based on the data-flow diagram.
Item 22. The system of Item 21, wherein the configuration data represents a directed acyclic graph (DAG), wherein the data-flow diagram corresponds with the DAG.
Item 23. The system of Item 21, wherein the data-flow diagram comprises a fan-in-node, a fan-out node, a filtering node, a check-and-emit node, an update state node, or any combination of two or more of the foregoing.
Item 24. The system of Item 21, wherein the processing unit comprises a converter configured to convert the communication data to a standardized format, wherein the standardized format comprises a routing format, a chat format, an attachment format, an adaptive card format, or a data event format.
Item 25. The system of Item 21, wherein the processing unit comprises an evaluator configured to evaluate the communication data using a check-and-emit node, and wherein the check-and-emit node is configured to evaluate the communication data to determine whether a condition is satisfied, and to emit an event if the condition is satisfied.
Item 26. The system of Item 21, wherein the processing scheme implemented based on the data-flow diagram involves a handoff between the chatbot and another chatbot, or between the first chatbot and a human agent.
Item 27. The system of Item 21, wherein the processing scheme implemented based on the data-flow diagram involves a sentiment analysis to detect customer frustration or customer desire to communicate with a human agent.

Item 28. The system of Item 21, wherein the system is part of an orchestration layer configured to manage interaction between the chatbot and on-premise component(s) of the contact center.
Item 29. The system of Item 21, wherein the system is a part of the data center, or is communicatively coupled with a component of the data center.
Item 30. The system of Item 21, further comprising:
   a user interface generator configured to provide a user interface for allowing a user to create the data-flow diagram implementing the processing scheme to process the communication data transmitted between the contact center and the chatbot;
   wherein the user interface comprises a first set of one or more data-flow control objects for selection by the user, and a second set of one or more entity objects for selection by the user;
   wherein the one or more data-flow control objects comprise a first data-flow control object configured to implement data-flow control for the processing scheme;
   wherein the one or more entity objects comprise a first entity object representing the chatbot; and
   wherein the data-flow diagram is configured to enable the contact center to process the communication data transmitted between the contact center and the chatbot in accordance with the processing scheme.
Item 31. A method involving a chatbot and a contact center, the method comprising:
   receiving, via a communication interface, communication data being transmitted between the contact center and the chatbot;
   accessing, by a processing unit, configuration data for a data-flow diagram from a non-transitory medium, the data-flow diagram implementing a processing scheme to process the communication data transmitted between the contact center and the chatbot; and
   causing the communication data to be routed according to the processing scheme implemented based on the data-flow diagram.
Item 32. The method of Item 31, wherein the configuration data represents a directed acyclic graph (DAG), wherein the data-flow diagram corresponds with the DAG.
Item 33. The method of Item 31, wherein the data-flow diagram comprises a fan-in-node, a fan-out node, a filtering node, a check-and-emit node, an update state node, or any combination of two or more of the foregoing.
Item 34. The method of Item 31, further comprising converting the communication data to a standardized format, wherein the standardized format comprises a routing format, a chat format, an attachment format, an adaptive card format, or a data event format.
Item 35. The method of Item 31, further comprising evaluating the communication data using a check-and-emit node, and wherein the check-and-emit node is configured to evaluate the communication data to determine whether a condition is satisfied, and to emit an event if the condition is satisfied.
Item 36. The method of Item 31, wherein the processing scheme implemented based on the data-flow diagram involves a handoff between the chatbot and another chatbot, or between the first chatbot and a human agent.
Item 37. The method of Item 31, wherein the processing scheme implemented based on the data-flow diagram involves a sentiment analysis to detect customer frustration or customer desire to communicate with a human agent.
Item 38. The method of Item 31, wherein the method is performed by a system that is a part of an orchestration layer configured to manage interaction between the chatbot and on-premise component(s) of the contact center.
Item 39. The method of Item 31, wherein the method is performed by a system that is a part of the data center, or is communicatively coupled with a component of the data center.
Item 40. The method of Item 31, further comprising:
   providing, by a user interface generator, a user interface for allowing a user to create the data-flow diagram implementing the processing scheme to process the communication data transmitted between the contact center and the chatbot;
   wherein the user interface comprises a first set of one or more data-flow control objects for selection by the user, and a second set of one or more entity objects for selection by the user;
wherein the one or more data-flow control objects comprise a first data-flow control object configured to implement data-flow control for the processing scheme;
wherein the one or more entity objects comprise a first entity object representing the chatbot; and
wherein the data-flow diagram is configured to enable the contact center to process the communication data transmitted between the contact center and the chatbot in accordance with the processing scheme.
Item 41. A product having a non-transitory medium storing a set of instructions, wherein an execution of the instructions will cause the method of Item 31 to be performed.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

What is claimed:

1. A system for integrating one or more chatbots with a contact center, the one or more chatbots comprising a first chatbot, the system comprising:
a user interface generator configured to provide a user interface for allowing a user to create a data-flow diagram implementing a processing scheme to process communication data transmitted between the contact center and the first chatbot;
wherein the user interface comprises a first set of one or more data-flow control objects for selection by the user, and a second set of one or more entity objects for selection by the user;
wherein the one or more data-flow control objects comprise a first data-flow control object configured to implement data-flow control for the processing scheme;
wherein the one or more entity objects comprise a first entity object representing a first chatbot; and
wherein the system is configured to enable the contact center to process the communication data transmitted between the contact center and the first chatbot in accordance with the processing scheme based on the created data-flow diagram.

2. The system of claim 1, wherein the one or more data-flow control objects comprise a second data-flow control object, and wherein the user interface is configured to allow the user to create a data path for the data-flow diagram, the data path connecting the first data-flow control object to the second data-flow control object, or to the first entity object.

3. The system of claim 1, wherein the system is configured to integrate the one or more chatbots with another contact center.

4. The system of claim 1, wherein the user interface comprises a display area configured to display a topography image representing the data-flow diagram, and wherein the first entity object is moveable in the display area.

5. The system of claim 1, wherein the one or more entity objects comprise a second entity object representing a second chatbot.

6. The system of claim 5, wherein the first chatbot and the second chatbot are associated with a same chatbot provider, or with different respective chatbot providers.

7. The system of claim 1, wherein the one or more entity objects comprise a second entity object representing at least a part of the contact center.

8. The system of claim 1, wherein the one or more entity objects comprises a second entity object representing an analytic tool or a processing tool.

9. The system of claim 1, wherein the first data-flow control object comprises a fan-out object having an input node and two or more output nodes.

10. The system of claim 1, wherein the first data-flow control object comprises a fan-in object having two or more input nodes and an output node.

11. The system of claim 1, wherein the first data-flow control object comprises a filter object implementing a filter that filters at least some of the communication data in response to a satisfaction of one or more criteria.

12. The system of claim 1, wherein the first data-flow control object comprises a check-and-emit object.

13. The system of claim 1, wherein the processing scheme implemented based on the data-flow diagram involves a handoff between the first chatbot and another chatbot, or between the first chatbot and a human agent.

14. The system of claim 1, wherein the processing scheme implemented based on the data-flow diagram involves a sentiment analysis to detect customer frustration or customer desire to communicate with a human agent.

15. The system of claim 1, wherein the user interface is configured to access a configuration interface from a chatbot provider to allow the user to create and/or to configure the first chatbot during a process to create the data-flow diagram.

16. The system of claim 15, wherein the user interface is configured to access another configuration interface from another chatbot provider to allow the user to create and/or to configure a second chatbot during the process to create the data-flow diagram.

17. The system of claim 1, wherein the system is a part of the data center or is communicatively coupled with the data center, and wherein the data center is configured to:
receive the communication data; and
process the communication data, in accordance with the communication scheme implemented based on the data-flow diagram.

18. A method involving one or more chatbots and a contact center, the one or more chatbots comprising a first chatbot, the method comprising:
providing a user interface by a user interface generator;
receiving user input to create a data-flow diagram, wherein the data-flow diagram is configured to implement a processing scheme to process communication data transmitted between the contact center and the first chatbot; and
storing configuration data based on the user input, the configuration data representing the created data-flow diagram.

19. The method of claim 18, wherein the method further comprises:
receiving the communication data; and
processing the communication data in accordance with the processing scheme implemented based on the data-flow diagram.

20. A system configured to integrate a contact center with a chatbot provided by a chatbot provider, the system comprising:
a communication interface configured to receive communication data being transmitted between the contact center and the chatbot;
a non-transitory medium storing configuration data regarding a data-flow diagram, the data-flow diagram implementing a processing scheme to process the communication data transmitted between the contact center and the chatbot; and
a processing unit configured to access the configuration data regarding the data-flow diagram, and to cause the communication data to be routed according to the processing scheme implemented based on the data-flow diagram.
